(19) United States
(12) Patent Application Publication
(10) Pub. No.: US 2019/0225629 A1
(43) Pub. Date: Jul. 25, 2019

(54) METHOD FOR PREPARING SILAHYDROCARBONS

(71) Applicant: UNIVERSITY OF DELAWARE, Newark, DE (US)

(72) Inventors: Donald Watson, Newark, DE (US); Andrew Cinderella, Elkton, MD (US); Bojan Vulovic, Vlaska (RS)

(73) Assignee: University of Delaware, Newark, DE (US)

(21) Appl. No.: 16/337,149

(22) PCT Filed: Sep. 27, 2017
(86) PCT No.: PCT/US2017/053714

§ 371 Date: Mar. 27, 2019

Related U.S. Application Data
(60) Provisional application No. 62/400,195, filed on Sep. 27, 2016.
(60) Provisional application No. 62/442,091, filed on Jan. 4, 2017.

(51) Int. Cl. C07F 7/08; C07F 7/12

(52) U.S. Cl. CPC C07F 7/0805; C07F 7/12; C07F 7/0834

(57) ABSTRACT

The present disclosure is directed to a process for preparing silahydrocarbons of formula (I):

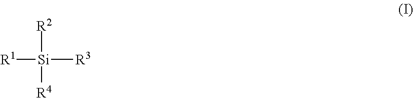

the process including the step of reacting a compound of formula (II):

R¹-MX (II)

with a compound of formula (III):

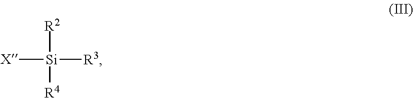

as well as to silahydrocarbons prepared by such a process, and to compositions and articles of manufacture containing such silahydrocarbons.

### RELATED APPLICATIONS

This application claims priority to U.S. Provisional Patent Application Serial Nos. 62/400,195, filed Sep. 27, 2016, and 62/442,091, filed Jan. 4, 2017, both of which are hereby incorporated by reference herein in their entireties.

### GOVERNMENT LICENSE RIGHTS

This invention was made with government support under Grant No. 1254360, awarded by the National Science Foundation (NSF). The government has certain rights in the invention.

### FIELD OF THE INVENTION

The present disclosure relates generally to processes for preparing silahydrocarbons. The present disclosure is also directed to silahydrocarbons prepared by such processes, as well as to compositions and articles of manufacture comprising such silahydrocarbons.

### BACKGROUND OF THE INVENTION

Silahydrocarbons are broadly useful materials and have a multitude of applications in basic science, medicine, and industry, including in materials, pharmaceuticals, and agrochemicals, as well as organic synthesis. The subtle steric, electronic, and spectroscopic differences between carbon and silicon are ideal for studies in bioisosterism. Small silicon-containing molecules are used as additives in rubber manufacturing (such as automobile tires), and silahydrocarbons are used as cryogenic fluids and as lubricants in aerospace applications due to drastically altered phase properties compared to their carbon analogues. Thus, methods to install a silicon atom with various substitution patterns in a rapid manner can have significant impact across a range of disciplines.

Syntheses of silahydrocarbons have been reported for over a century. Historically, hydrosilylation has been a workhorse reaction for the synthesis of n-alkylsilanes. However, hydrosilylation often encounters issues of isomerization and regioselectivity with 1,2-disubstituted olefins. Arguably, the most attractive method for preparing alkyl silanes is the alkylation of widely available silyl electrophiles with equally abundant organometallic nucleophiles. Unfortunately, these reactions suffer from low yields, long reaction times, and significant side reactions. Alkylations with primary and aryl nucleophiles are known. However, the addition of secondary organometallic reagents to silyl electrophiles is rarely effective. In fact, over the past seventy years only five isolated examples with secondary nucleophiles have been reported in the chemical literature. This is due to lack of reactivity or competitive reductive processes with these more sterically demanding and electron-rich nucleophiles. Prior catalytic methods, which have proven effective with primary and aryl nucleophiles, are ineffective in coupling secondary alkyl groups.

In an effort to circumvent this poor reactivity, developments have been made in the cross-coupling of silyl nucleophiles and carbon electrophiles. While these are highly valuable transformations that allow access to secondary alkyl silanes, they rely on nucleophilic silicon reagents, the umpolung reactivity of naturally electropositive silicon. Since silyl electrophiles are the main feedstock of silicon reagents, developing a general method of alkyl silane synthesis from these abundant and cheap starting materials is highly appealing.

Furthermore, the development of cross-coupling conditions that allow for the use of silyl chlorides would be a significant advance, as silyl chlorides are not only much less air and moisture sensitive, they are much more abundant and functional group tolerant than silyl iodides. Whereas silyl iodides typically require multiple steps to access, chlorosilanes are the product of the Müller-Rochow “Direct” Process, which is widely practiced on commodity scale. Thus, the ability to directly engage monochlorosilanes in cross-coupling is important for the ability to modify feedstock chemicals of critical importance to the silane industry.

Despite this appeal, the high bond strength of the Si—Cl bond (113 kcal/mol) has severely hampered the development of transition metal methods involving its activation. Reports of productive chlorosilane activation have been limited to the weaker Si—Cl bonds of polychloro- or hydrochlorosilanes. However, those reactions have not been exploited in synthetic applications. In addition, three reports of monochlorosilane activation using iridium (I) complexes have also been described, but the resultant silyliridium chlorides are unstable to β-hydride elimination.

Finally, several metal-catalyzed arylations of monochlorosilanes have been reported. However, these reactions are believed to proceed via nucleophile activation, and not via activation of the Si—Cl bond. Moreover, none of those conditions exhibited any advantage in the case of alkyl Grignard reagents.

Thus, there exists a continuing need for improved processes for synthesizing silahydrocarbons, particularly with regard to coupling secondary alkyl groups and the ability to leverage the advantages of silyl chlorides.

### Embodiments of the Invention

This need is met by the process of the present invention.

Thus, one embodiment of the present invention is a process for preparing a compound of formula (I):

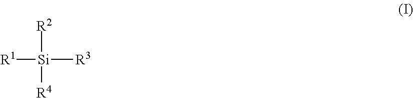

comprising the step of reacting a compound of formula (II):

R¹-MX (II)

wherein M is Zn or Mg; R¹ is an alkyl, alkenyl, alkynyl, cycloalkyl, cycloalkenyl, cycloalkynyl, heterocycloalkyl, heterocycloalkenyl, heterocycloalkynyl, aryl, or heteroaryl group, each of which is optionally substituted with one or more substituents, wherein at least one of the one or more substituents is optionally a moiety of formula -M′X′, wherein M′ is Zn or Mg and X′ is Cl, Br, or I; and X is Cl, Br, or I, or, when R¹ is an alkyl group, X is optionally an alkyl group identical to that of R¹; with a compound of formula (III):

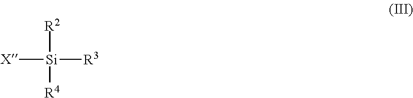

wherein X″ is Cl, Br, I, —OS(O)₂alkyl, —OS(O)₂perfluoroalkyl, or —OS(O)₂aryl; and R², R³, and R⁴ are, independently, selected from the group consisting of alkyl, alkenyl, alkynyl, cycloalkyl, cycloalkenyl, cycloalkynyl, heterocycloalkyl, heterocycloalkenyl, heterocycloalkynyl, aryl, heteroaryl, wherein each alkyl, alkenyl, alkynyl, cycloalkyl, cycloalkenyl, cycloalkynyl, heterocycloalkyl, heterocycloalkenyl, heterocycloalkynyl, aryl, heteroaryl group is optionally substituted with one or more substituents, Cl, Br, I, —OS(O)₂alkyl, —OS(O)₂perfluoroalkyl, and —OS(O)₂aryl groups, wherein at least one of the one or more substituents is optionally a moiety of formula —SiR⁵R⁶X′″, wherein R⁵ and R⁶ are each, independently, selected from the group consisting of alkyl, alkenyl, alkynyl, cycloalkyl, cycloalkenyl, cycloalkynyl, heterocycloalkyl, heterocycloalkenyl, heterocycloalkynyl, aryl, heteroaryl, each of which is optionally substituted with one or more substituents, and X′″ is Cl, Br, I, —OS(O)₂alkyl, —OS(O)₂perfluoroalkyl, or —OS(O)₂aryl; and wherein R², R³, and/or R⁴, when taken together, optionally define an optionally substituted ring system; in the presence of a catalyst comprising a Group 8, 9, or 10 transition metal, a ligand, a solvent, and, optionally, an additive; wherein R², R³, and/or R⁴ are optionally covalently linked to R¹; and R¹, R², R³, and R⁴ of the compound of formula (I) are as defined above.

In certain embodiments of the above process, R¹ is sterically hindered. In certain embodiments of the above process, R¹ is selected from the group consisting of primary, secondary and tertiary alkyl groups, primary, secondary and tertiary alkenyl groups, and primary, secondary and tertiary alkynyl groups, each of which is optionally substituted. In certain embodiments of the above process, one or more of R¹, R², R³, and R⁴ is substituted with a least one silyl group.

In certain embodiments of the above process, R² is selected from the group consisting of Cl, Br, I, —OS(O)₂alkyl groups, —OS(O)₂perfluoroalkyl groups, and —OS(O)₂aryl groups. In certain embodiments of the above process, R³ is selected from the group consisting of Cl, Br, I, —OS(O)₂alkyl groups, —OS(O)₂perfluoroalkyl groups, and —OS(O)₂aryl groups. In certain embodiments of the above process, R⁴ is selected from the group consisting of Cl, Br, I, —OS(O)₂alkyl groups, —OS(O)₂perfluoroalkyl groups, and —OS(O)₂aryl groups. In certain embodiments, X″ and R² are both Cl. In certain embodiments, X″, R², and R³ are all Cl.

In certain embodiments of the above process, the Group 8, 9, or 10 transition metal is selected from the group consisting of Pd, Ni, Co, Rh, and Ir. In certain embodiments of the above process, the catalyst comprises Pd and is selected from the group consisting of Pd(OAc)₂, PdBr₂, PdI₂, Pd(dba)₂, Pd(dba)₃, [allylPdCl]₂, Pd₂dba₃.CHCl₃, [(3,5-C₆H₃(t-Bu)₂)₃P]₂PdI₂, [(3,5-C₆H₃(t-Bu)₂)₃P]₂PdCl₂, (COD)Pd(CH₂TMS)₂, (COD)PdCl₂, (PPh₃)₂PdCl₂, (PPh₃)₄Pd, and (MeCN)₂PdCl₂. In certain embodiments of the above process, the catalyst comprises Ni and is selected from the group consisting of Ni halide salts, Ni halide solvent complexes, and Ni(COD)₂.

In certain embodiments of the above process, the ligand is selected from the group consisting of phosphine ligands, arsine ligands, nitrogen-containing ligands, and N-heterocyclic carbene ligands. In certain embodiments of the above process, the ligand is selected from the group consisting of PPh₃, (3,5-t-BuC₆H₃)₂P(tBu), Ph₂P(tBu), PhP(t-Bu)₂, (3,5-C₆H₃(t-Bu)₂)₃P, (4-MeO—C₆H₄)₃P, (t-Bu)₃P, (t-Bu)₂PCy, (t-Bu)PCy₂, Cpy₃P, Cy₂PMe, Cy₂PEt, Cy₃P, (o-tol)₃P, (furyl)₃P, (4-F—C₆H₄)₃P, (4-CF₃—C₆H₄)₃P, BIPHEP, NapthPhos, XantPhos, dppf, dppe, dppb, dpppe, dcpe, dcpp, dcpb, SPhos, XPhos, DavePhos, JohnPhos, BrettPhos, QPhos, AmgenPhos, RockPhos, RuPhos, VPhos, tBuXPhos, tBuBrettPhos, TrixiePhos, AZPhos, CPhos, (3,5-t-BuC₆H₃)₂P(iPr), (3,5-t-BuC₆H₃)₂P(Et), (3,5-t-BuC₆H₃)₂P(Me), (3,5-i-PrC₆H₃)₂P(tBu), (3,5-i-PrC₆H₃)₂P(iPr), (3,5-i-PrC₆H₃)₂P(Et), (3,5-i-PrC₆H₃)₂P(Me), (3,5-t-Bu-4-MeO—C₆H₂)₂P(tBu), (3,5-t-Bu-4-MeO—C₆H₂)₃P, BINAP, SIPr, IPr, IMes, ISMes, and derivatives thereof.

In certain embodiments of the above process, the solvent is selected from the group consisting of dioxane, toluene, 1,2-dichloroethane, acetonitrile, dibutyl ether, diethyl ether, hexane, tetrahydrofuran, and mixtures thereof.

In certain embodiments of the above process, additive is present during the reaction and is selected from the group consisting of trialkylamines and iodide salts. In certain embodiments, the additive is triethylamine or TMEDA. In certain embodiments, the additive is LiI, NaI, KI, or ammonium iodide salts.

In certain embodiments of the above process, M and X of the compound of formula (II) are Zn and Br or I, respectively, X″ of the compound of formula (III) is I, the catalyst is [(3,5-C₆H₃(t-Bu)₂)₃P]₂PdI₂, the additive is triethylamine, and the solvent is dioxane. In certain embodiments, M and X of the compound of formula (II) are Mg and Br or I, respectively, X″ of the compound of formula (III) is Cl, the catalyst is [(3,5-C₆H₃(t-Bu)₂)₃P]₂PdI₂, and the solvent is Et₂O.

Another embodiment of the present invention is a compound of formula (I):

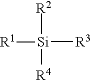

wherein R¹, R², R³, and R⁴ are each, independently, an alkyl, alkenyl, alkynyl, cycloalkyl, cycloalkenyl, cycloalkynyl, heterocycloalkyl, heterocycloalkenyl, heterocycloalkynyl, aryl, or heteroaryl group, each of which is optionally substituted with one or more substituents; wherein R², R³, and/or R⁴, when taken together, optionally define an optionally substituted ring system; and R², R³, and/or R⁴ are optionally covalently linked to R¹.

In certain embodiments of the above compound, R¹ is sterically hindered. In certain embodiments of the above compound, R¹ is selected from the group consisting of secondary and tertiary alkyl groups, secondary and tertiary alkenyl groups, and secondary and tertiary alkynyl groups, each of which is optionally substituted. In certain embodiments of the above compound, one or more of R¹, R², R³, and R⁴ is substituted with a least one silyl group.

In certain embodiments, the above compound is selected from the group consisting of compounds of formulae (2), (3), (7)-(9), (13), (16)-(23), (25)-(27), and (30)-(47):

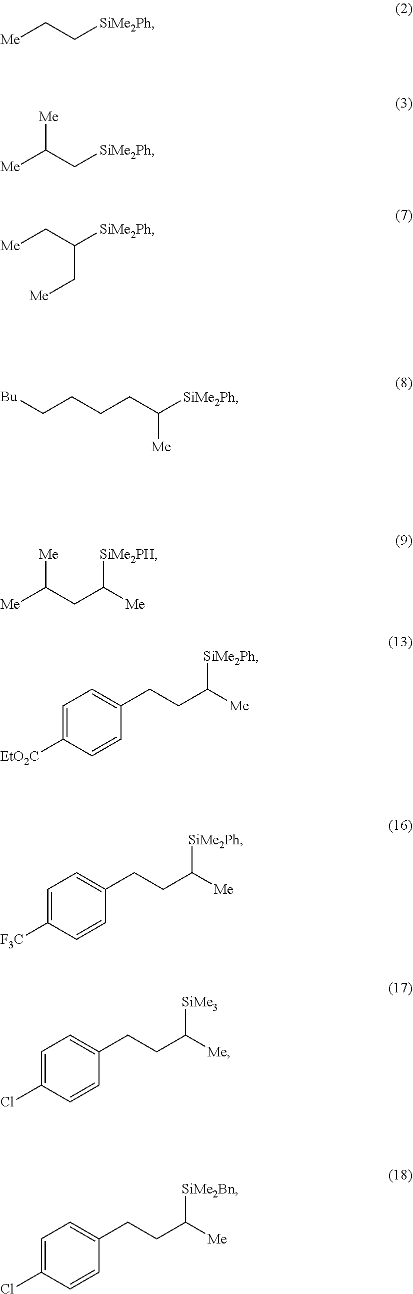

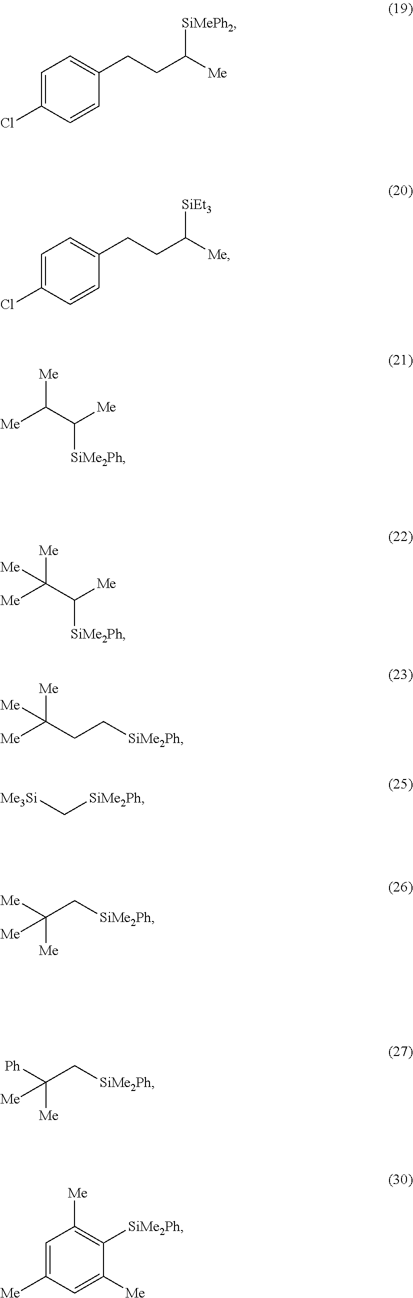

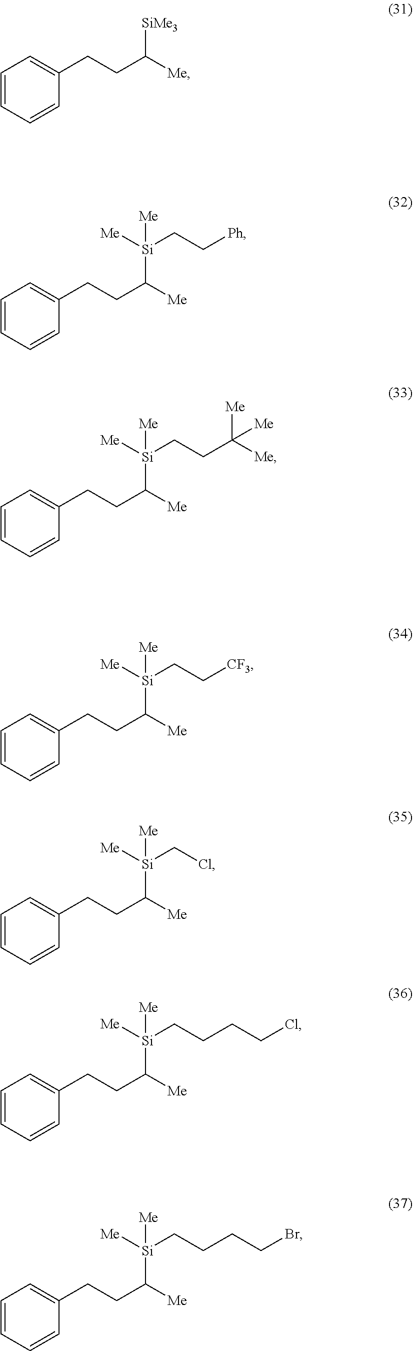

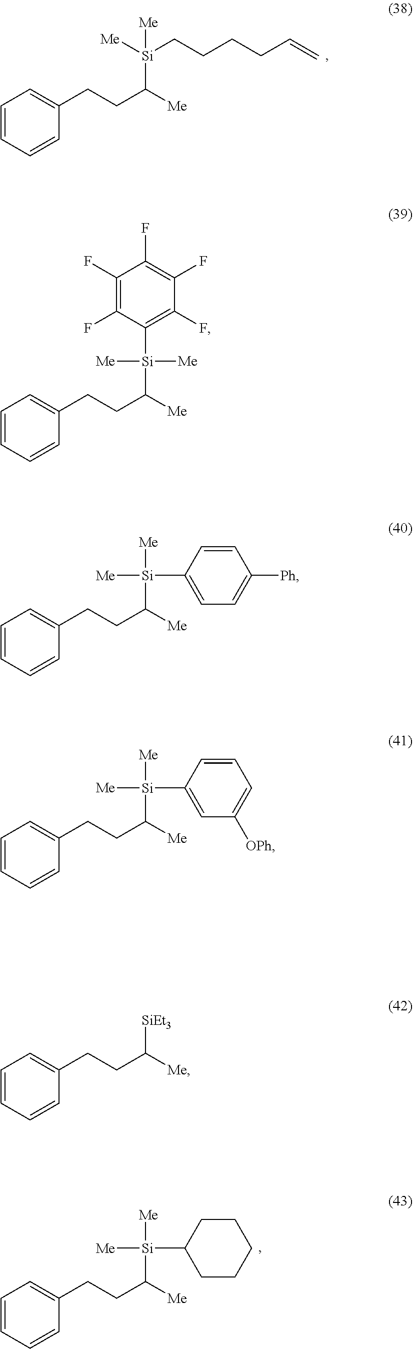

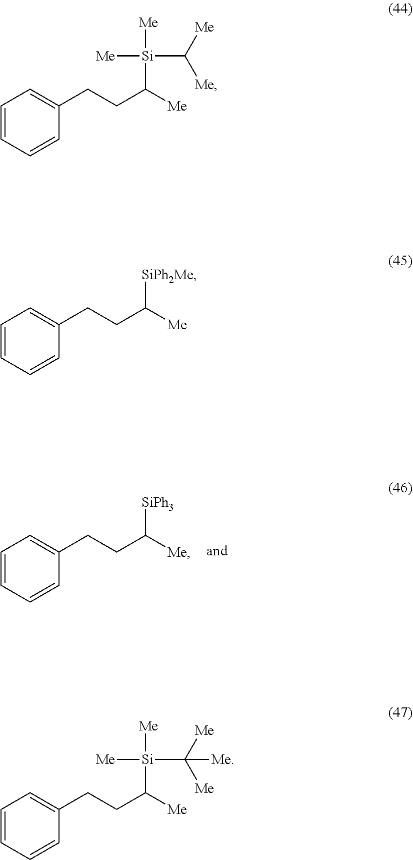

Another embodiment of the present invention is a composition comprising at least one of the above compounds of formula (I). In certain embodiments, the composition is selected from the group consisting of aerospace materials, pharmaceuticals, agrochemicals, rubber materials, lubricants, hydraulic fluids, damping fluids, diffusion pump fluids, cryogenic fluids, waterproofing agents, hydrophobing agents, heat transfer media, anti-stick coatings, and fuel additives.

### DETAILED DESCRIPTION OF THE INVENTION

In one aspect of the present invention, the present disclosure provides for a process for preparing a compound of formula (I):

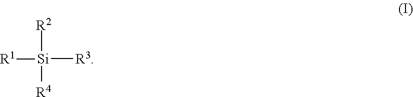

The process comprises the step of reacting a compound of formula (II):

R¹-MX (II)

with a compound of formula (III):

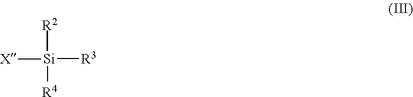

In the compounds of formula (II), M is Zn or Mg and R¹ is an alkyl, alkenyl, alkynyl, cycloalkyl, cycloalkenyl, cycloalkynyl, heterocycloalkyl, heterocycloalkenyl, heterocycloalkynyl, aryl, or heteroaryl group, each of which is optionally substituted with one or more substituents. At least one of these one or more substituents may optionally be a moiety of formula -M′X′, wherein M′ is Zn or Mg and X′ is Cl, Br, or I. Variable X of the compounds of formula (II) is Cl, Br, or I, or, when R¹ is an alkyl group, X is optionally an alkyl group identical to that of R¹. In certain embodiments, R¹ is a sterically hindered group, such as a primary, secondary, or tertiary alkyl, alkenyl, or alkynyl group, each of which is optionally substituted.

In the compounds of formula (III), X″ is Cl, Br, I, —OS(O)₂alkyl, —OS(O)₂perfluoroalkyl, or —OS(O)₂aryl. Examples of —OS(O)₂alkyl, —OS(O)₂perfluoroalkyl, and —OS(O)₂aryl groups include, but are not limited to, methanesulfonate, trifluoromethanesulfonate, and toluenesulfonate groups, respectively. R², R³, and R⁴ of the compounds of formula (III) are, independently, selected from the group consisting of alkyl, alkenyl, alkynyl, cycloalkyl, cycloalkenyl, cycloalkynyl, heterocycloalkyl, heterocycloalkenyl, heterocycloalkynyl, aryl, heteroaryl, wherein each alkyl, alkenyl, alkynyl, cycloalkyl, cycloalkenyl, cycloalkynyl, heterocycloalkyl, heterocycloalkenyl, heterocycloalkynyl, aryl, heteroaryl group is optionally substituted with one or more substituents, as well as from Cl, Br, I, —OS(O)₂alkyl, —OS(O)₂perfluoroalkyl, and —OS(O)₂aryl groups. In certain embodiments, R², R³, and/or R⁴, when taken together, optionally define an optionally substituted ring system. Furthermore, R², R³, and/or R⁴ are optionally covalently linked to R¹ of the compound of formula (II).

In certain embodiments, at least one of the one or more optional substituents on R², R³, and R⁴ of the compounds of formula (III) may be a moiety of formula —SiR⁵R⁶X′″. R⁵ and R⁶ are each, independently, selected from the group consisting of alkyl, alkenyl, alkynyl, cycloalkyl, cycloalkenyl, cycloalkynyl, heterocycloalkyl, heterocycloalkenyl, heterocycloalkynyl, aryl, heteroaryl, each of which, in turn, is optionally substituted with one or more substituents. X′″ is Cl, Br, I, —OS(O)₂alkyl, —OS(O)₂perfluoroalkyl, or —OS(O)₂aryl.

In certain embodiments, in addition to X″, R² and/or R³ and/or R⁴ of the compound of formula (III) is selected from the group consisting of Cl, Br, I, —OS(O)₂alkyl groups, —OS(O)₂perfluoroalkyl groups, and —OS(O)₂aryl groups. Examples of such compounds of formula (III) include, but are not limited to, dimethyldichlorosilane (i.e, Me₂SiCl₂) and trichlorophenylsilane (i.e., PhSiCl₃). These polychlorosilanes can be monoalkylated with alkyl zinc halides, as shown in the following reaction schemes:

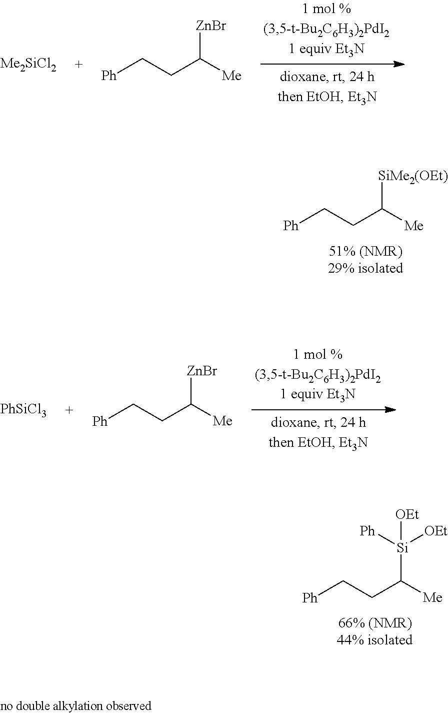

The respective ethoxy-substituted products result from post-reaction workup with ethanol to yield a stable adduct.

The compounds of formula (II) and (III) are reacted in the presence of a catalyst comprising a Group 8, 9, or 10 transition metal, a ligand, a solvent, and, optionally, an additive.

Any suitable catalyst comprising a Group 8, 9, or 10 transition metal (e.g., Fe, Ru, Os, Co, Rh, Ir, Ni, Pd, and Pt) may be used in the processes of the present invention. In certain embodiments, the catalyst comprises a Group 8, 9, or 10 transition metal selected from the group consisting of Pd, Ni, Co, Rh, and Ir. In embodiments where the catalyst comprises Pd, examples of such catalysts include, but are not limited to, Pd(OAc)₂, PdBr₂, PdI₂, Pd(dba)₂, Pd(dba)₃, [allylPdCl]₂, Pd₂dba₃*CHCl₃, [(3,5-C₆H₃(t-Bu)₂)₃P]₂PdI₂, [(3,5-C₆H₃(t-Bu)₂)₃P]₂PdCl₂, (COD)Pd(CH₂TMS)₂, (COD)PdCl₂, (PPh₃)₂PdCl₂, (PPh₃)₄Pd, and (MeCN)₂PdCl₂. In embodiments, where the catalyst comprises Ni, examples of such catalysts include, but are not limited to, Ni halide salts, Ni solvent complexes, and Ni(COD)₂.

Any suitable ligand may be used in the processes of the present invention. Examples of classes of such ligands include, but are not limited to, phosphine ligands, arsine ligands, nitrogen-containing ligands, and N-heterocyclic carbene (NHC) ligands. An example of an NHC ligand that may be used in the processes of the present invention includes, but is not limited to, a ligand having the following structure:

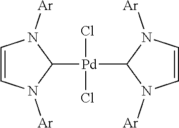

For example, this particular ligand can be used to alkylate Me₂PhSiCl with cyclohexylmagnesium bromide, as shown in the following reaction scheme:

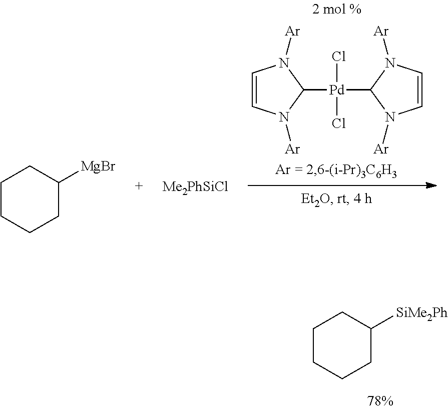

Examples of other particular ligands that may be used, include, but are not limited to, PPh₃, (3,5-t-BuC₆H₃)₂P(tBu), Ph₂P(tBu), PhP(t-Bu)₂, (3,5-C₆H₃(t-Bu)₂)₃P, (4-MeO—C₆H₄)₃P, (t-Bu)₃P, (t-Bu)₂PCy, (t-Bu)PCy₂, Cpy₃P, Cy₂PMe, Cy₂PEt, Cy₃P, (o-tol)₃P, (furyl)₃P, (4-F—C₆H₄)₃P, (4-CF₃—C₆H₄)₃P, BIPHEP, NapthPhos, XantPhos, dppf, dppe, dppb, dpppe, dcpe, dcpp, dcpb, SPhos, XPhos, DavePhos, JohnPhos, BrettPhos, QPhos, AmgenPhos, RockPhos, RuPhos, VPhos, tBuXPhos, tBuBrettPhos, TrixiePhos, AZPhos, CPhos, (3,5-t-BuC₆H₃)₂P(iPr), (3,5-t-BuC₆H₃)₂P(Et), (3,5-t-BuC₆H₃)₂P(Me), (3,5-i-PrC₆H₃)₂P(tBu), (3,5-i-PrC₆H₃)₂P(iPr), (3,5-i-PrC₆H₃)₂P(Et), (3,5-i-PrC₆H₃)₂P(Me), (3,5-t-Bu-4-MeO—C₆H₂)₂P(tBu), (3,5-t-Bu-4-MeO—C₆H₂)₃P, BINAP, SIPr, IPr, IMes, ISMes, and derivatives thereof. In certain embodiments, the ligand can be a XantPhos derivative having the following structure:

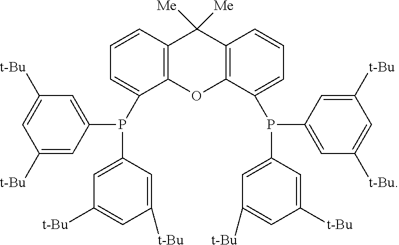 [SMILES: CC(C)(C)c1cc(P(c2cc(C(C)(C)C)cc(C(C)(C)C)c2)c2cccc3c2Oc2c(P(c4cc(C(C)(C)C)cc(C(C)(C)C)c4)c4cc(C(C)(C)C)cc(C(C)(C)C)c4)cccc2C3(C)C)cc(C(C)(C)C)c1]

Any suitable solvent may be used in the processes of the present invention. Examples of such solvents include, but are not limited to, dioxane, toluene, 1,2-dichloroethane, acetonitrile, dibutyl ether, diethyl ether, hexane, tetrahydrofuran, and mixtures thereof.

Additives that facilitate the processes of the present invention may be present during the reaction. Examples of such additives include, but are not limited to, trialkylamines, such as triethylamine, TMEDA, and iodide salts, such as LiI, NaI, KI, or ammonium iodide salts.

The processes according the present invention can be performed at any suitable temperature. Examples of suitable temperatures include, but are not limited to, temperatures in the range of from −78° C. to 100° C. In certain embodiments, the reaction temperature is room or ambient temperature, i.e., approximately 20 to 25° C. In certain other embodiments, the reaction temperature is 50° C.

In another aspect of the present invention, the present disclosure provides for compounds of formula (I):

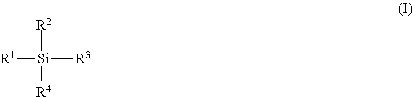

wherein R¹, R², R³, and R⁴ are as defined above. Substituents R², R³, and/or R⁴, when taken together, optionally define an optionally substituted ring system and are optionally covalently linked to R¹. In certain embodiments, R¹ is a sterically hindered group, such as an optionally substituted secondary and tertiary alkyl, alkenyl, or alkynyl group. In certain embodiments, one or more of groups R, R², R³, and R⁴ is substituted with a least one silyl group.

In another aspect of the present invention, the present disclosure provides for compositions and articles comprising at least one compound of formula (I). Examples of such compositions and articles include, but are not limited to, aerospace materials, pharmaceuticals, agrochemicals, rubber materials, lubricants, hydraulic fluids, damping fluids, diffusion pump fluids, cryogenic fluids, waterproofing agents, hydrophobing agents, heat transfer media, anti-stick coatings and fuel additives.

The following examples are included to demonstrate preferred embodiments. It should be appreciated by those of skill in the art that the techniques disclosed in the examples which follow represent techniques discovered by the inventor to function well in the practice of the products, compositions, and methods described herein, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### EXAMPLES

General Experimental Details

Dioxane, trimethylamine, toluene, dibutyl ether (Bu₂O), diethyl ether (Et₂O), methyl tert-butyl ether (MTBE), triethylamine, dichloromethane (DCM), acetonitrile (MeCN), and tetrahydrofuran (THF), were dried on alumina according to published procedures. Cyclopentylmethyl ether (CPME) was dried over CaH₂, distilled under N₂, and stored in a Straus flask.

The following Grignard reagents were purchased from commercial suppliers and titrated with iodine before use: phenylmagnesium bromide [3M] in Et₂O (Aldrich), ortho-tolylmagnesium bromide [2M] in Et₂O (Aldrich), 2-mesitylmagnesium bromide [1M] in Et₂O (Aldrich), cyclopentylmagnesium bromide [2M] in Et₂O (Acros), and 2-methyl-2-phenylpropylmagnesium chloride [0.5M] in Et₂O (Acros).

Instrumentation and Chromatography

400 MHz ¹H, 101 MHz ¹³C, and 376 MHz ¹⁹F spectra were obtained on a 400 MHz FT-NMR spectrometer equipped with a Bruker CryoPlatform. 600 MHz ¹H, 151 MHz ¹³C, 119 MHz ²⁹Si, and 243 MHz ³¹P spectra were obtained on a 600 MHz FT-NMR spectrometer equipped with a Bruker SMART probe. All samples were analyzed in the indicated deutero-solvent and were recorded at ambient temperatures. All chemical shifts are reported in ppm. ¹H NMR spectra were calibrated using the residual protio-signal in deutero-solvents as a standard. ¹³C NMR spectra were calibrated using the deutero-solvent as a standard. Product ²⁹Si spectra were calibrated using a hexamethyldisiloxane capillary standard at 7.32 ppm. IR spectra were recorded on a Nicolet Magma-IR 560 FT-IR spectrometer as thin films on KBr plates. High resolution MS data was obtained on a Waters GCT Premier spectrometer using chemical ionization (CI), electron ionization (EI), or liquid injection field desorption ionization (LIFDI). Vacuum controller refers to J-Kem Digital Vacuum Regulator Model 200. Unless otherwise noted, column chromatography was performed either by hand or by use of Isolera 4 Biotage unit with 40-63 μm silica gel, and the eluent reported in parentheses. Analytical thin-layer chromatography (TLC) was performed on silica gel (60 F₂₅₄ Merck) pre-coated glass plates and visualized by UV or by staining with iodine, KMnO₄, or ceric ammonium molybdate (CAM).

### Synthesis of Ligand “DrewPhos”

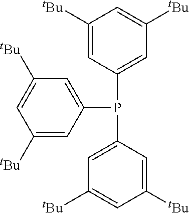 [SMILES: CC(C)(C)c1cc(P(c2cc(C(C)(C)C)cc(C(C)(C)C)c2)c2cc(C(C)(C)C)cc(C(C)(C)C)c2)cc(C(C)(C)C)c1]

An oven-dried 500 mL round bottom flask equipped with a magnetic stir bar and rubber septum was attached to a double manifold and cooled under vacuum. The flask was backfilled with N₂, the rubber septum was removed, 1-bromo-3,5-di-tert-butylbenzene (32.4 g, 120 mmol, 3.01 equiv.) was added, and the septum replaced. The flask was then purged with N₂ for 15 minutes. THF (240 mL, [0.5 M]) was added and the flask was cool to −78° C. in a dry ice/acetone bath. While stirring, nBuLi (48.2 mL, 120 mmol, 3 equiv., [2.49 M] in hexanes) was added dropwise via syringe pump over 30 minutes. PCl₃ (3.5 mL, 40 mmol, 1 equiv.) was added dropwise via syringe pump over 15 minutes. After the addition was complete, the flask was warmed to 0° C. in an ice/water bath and stirred for 4 hours. The flask was allowed to warm to RT, the septum was removed and the reaction was quenched by adding brine (100 mL). The reaction was poured into a separatory funnel and the product was extracted 2× with Et₂O (100 mL). The organic layer was dried over MgSO₄, filtered through a glass frit, and the solvent removed in vacuo. The product was purified by recrystallization from hot EtOH (200 mL), cooled under ambient conditions, then placed in a −20° C. freezer overnight. Collection of the solid via filtration and washing with EtOH resulted in white crystals (10.6 g, 44% yield): ¹H NMR (600 MHz, CDCl₃) δ 7.38 (t, J=1.8 Hz, 3H), 7.12 (dd, J=8.5, 1.8 Hz, 6H), 1.22 (s, 54H); ¹³C NMR (151 MHz, CDCl₃) δ 150.6 (d, J=6.7 Hz), 137.3 (d, J=9.4 Hz), 128.1 (d, J=19.3 Hz), 122.4, 35.0, 31.5; ³¹P NMR (243 MHz, CDCl₃) δ −3.59; FTIR (cm⁻¹): 2963, 1589, 1577, 1362, 1249, 1130, 875, 710; mp=145-147° C.; HRMS (LIFDI) m/z, calculated for [C₄₂H₆₃P]⁺: 598.4667; found: 598.4688.

### Synthesis of Catalyst (DrewPhos)₂PdI₂

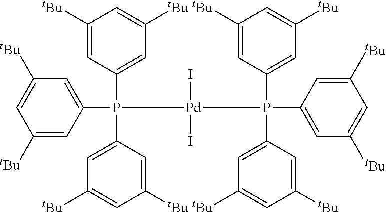

A 50 mL round bottom flask equipped with a magnetic stirbar was charged with palladium(II) iodide (1.08 g, 3 mmol, 1.0 equiv.) and DrewPhos (3.59 g, 6 mmol, 2.0 equiv.). The flask was sealed with a rubber septum and purged 10 min with N₂. Toluene (24 mL) was added via syringe and the reaction was stirred for 24 hours at 85° C. The reaction was cooled to RT, transferred to a 250 mL round bottom flask and the solvent evaporated in vacuo. The resulting solid was recrystallized from hot 3:1 ethanol:toluene (100 mL), cooled under ambient conditions, then placed in a −20° C. [symbol] freezer overnight. Collection of the solid via filtration resulted in a stable, red solid (3.52 g, 75% yield). A second crop of product was obtained by subsequent recrystallization with same solvent system resulted in red crystals (900 mg, 19%). Total 4.42 g, 95%: ¹H NMR (600 MHz, CDCl₃) δ 7.60-7.54 (m, 12H), 7.29 (s, 6H), 1.21 (s, 108H); ¹³C NMR (151 MHz, CDCl₃) δ 149.2 (t, J=5.1 Hz), 134.5 (t, J=24.9 Hz), 129.9 (t, J=6.2 Hz), 123.2, 35.1, 31.6; ³¹P NMR (243 MHz, CDCl₃) δ 18.90; FTIR (cm⁻¹): 2953, 1589, 1384, 1247, 1087, 702, 584; mp=>250° C. HRMS (LIFDI) m/z, calculated for [C₈₄H₁₂₆P₂PdI]⁺:1429.7414; found: 1429.7373.

### Synthesis of Alkyl Zinc Halides

General Procedure

An oven dried Schlenk flask equipped with a magnetic stirbar and rubber septum was attached to a double manifold and cooled under vacuum. The flask was backfilled with N₂, the septum removed, and zinc dust (2 equiv.) added. The septum was replaced; the flask was attached to a double manifold and evacuated. Under vacuum, the zinc was heated for 5 minutes with a heat gun then allowed to cool to RT under vacuum. The flask was backfilled with N₂ then dioxane [2 M], trimethylsilyl chloride (0.03 equiv), and alkyl bromide (1 equiv) were added. The flask was then stirred in an oil bath at 100° C. for the indicated time. Conversion of starting halide was monitored via GC by quenching reaction aliquots with saturated NH₄Cl solution and extracting with Et₂O. Once all starting halide was consumed, the excess zinc was allowed to settle while the flask cooled. The mixture was filtered via cannula to a Schlenk tube. If insoluble particles persist, filtration through a 0.2 μm PTFE syringe filter was employed. Solutions were then titrated according to the literature procedure by Knochel.

### Synthesis of Cyclohexylzinc Iodide

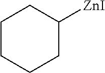

According to the general procedure, a 25 mL Schlenk flask was charged with zinc dust (3.92 g, 60 mmol), dioxane (15 mL), trimethylsilyl chloride (115 μL, 98 mg, 0.9 mmol), and cyclohexyl iodide (3.88 mL, 6.3 g, 30 mmol). The flask was heated to 100° C. for 12 hours. Filtration and titration resulted in a [0.97 M] solution of cyclohexylzinc iodide in dioxane.

### Synthesis of Isopropylzinc Iodide

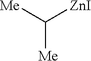

According to the general procedure, a 25 mL Schlenk flask was charged with zinc dust (3.92 g, 60 mmol), dioxane (15 mL), trimethylsilyl chloride (115 μL, 98 mg, 0.9 mmol), and isopropyl iodide (3.0 mL, 5.1 g, 30 mmol). The flask was heated to 100° C. for 20 hours. Filtration and titration resulted in a [1.56 M] solution of isopropylzinc iodide in dioxane.

### Synthesis of Isopropylzinc Bromide

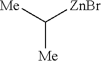

According to the general procedure, a 25 mL Schlenk flask was charged with zinc dust (3.92 g, 60 mmol), dioxane (15 mL), trimethylsilyl chloride (120 μL, 102 mg, 0.9 mmol), and isopropyl bromide (2.9 mL, 3.8 g, 31 mmol). The flask was heated to 100° C. for 20 hours. Filtration and titration resulted in a [1.81 M] solution of isopropylzinc bromide.

### Synthesis of Isobutylzinc Iodide

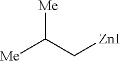

According to the general procedure, a 25 mL Schlenk flask was charged with zinc dust (3.92 g, 60 mmol), dioxane (15 mL), trimethylsilyl chloride (115 μL, 98 mg, 0.9 mmol), and isobutyl iodide (3.6 mL, 5.8 g, 30 mmol). The flask was heated to 100° C. for 17 hours. Filtration and titration resulted in a [1.59 M] solution of isobutylzinc iodide in dioxane.

### Synthesis of Isobutylzinc Bromide

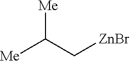

According to the general procedure, a 25 mL Schlenk flask was charged with zinc dust (3.92 g, 60 mmol), dioxane (15 mL), trimethylsilyl chloride (115 μL, 98 mg, 0.9 mmol), and isobutyl bromide (3.3 mL, 4.2 g, 30 mmol). The flask was heated to 100° C. for 17 hours. Filtration and titration resulted in a [1.40 M] solution of isobutylzinc bromide in dioxane.

### Synthesis of n-Propylzinc Iodide

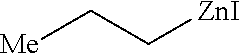

According to the general procedure, a 25 mL Schlenk flask was charged with zinc dust (1.52 g, 23 mmol), dioxane (6 mL), trimethylsilyl chloride (50 μL, 45 mg, 0.4 mmol), and n-propyl iodide (1.5 mL, 2.61 g, 15 mmol). The flask was heated to 100° C. for 20 hours. Filtration and titration resulted in a [2.25 M] solution of n-propylzinc iodide in dioxane.

### Synthesis of Cyclopentylzinc Bromide

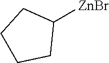

According to the general procedure, a 25 mL Schlenk flask was charged with zinc dust (2.6 g, 40 mmol), dioxane (10 mL), trimethylsilyl chloride (80 μL, 66 mg 0.6 mmol), and cyclopentyl bromide (2.2 mL, 20 mmol). The flask was heated to 100° C. for 18 hours. Filtration and titration resulted in a [0.89 M] solution of cyclopentylzinc bromide.

### Synthesis of n-Butylzinc Bromide

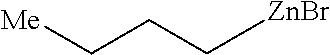

According to the general procedure, a 25 mL Schlenk flask was charged with zinc dust (3.92 g, 60 mmol), dioxane (15 mL), trimethylsilyl chloride (115 μL, 98 mg, 0.9 mmol), and n-butyl bromide (3.3 mL, 4.2 g, 30 mmol). The flask was heated to 100° C. for 17 hours. Filtration and titration resulted in a [1.51 M] solution of n-butylzinc bromide in dioxane.

### Synthesis of Pentan-3-ylzinc Bromide

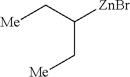

According to the general procedure, a 25 mL Schlenk flask was charged with zinc dust (2.6 g, 40 mmol), dioxane (10 mL), trimethylsilyl chloride (80 μL, 66 mg 60 μmol), and 3-bromopentane (2.5 mL, 3.0 g, 20 mmol). The flask was heated to 100° C. for 4 hours. Filtration and titration resulted in a [1.35 M] solution of pentan-3-ylzinc bromide.

### Synthesis of 1-Octylethylzinc Bromide

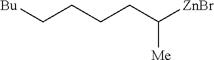

According to the general procedure, a 25 mL Schlenk flask was charged with zinc dust (2.1 g, 32 mmol), dioxane (8 mL), trimethylsilyl chloride (60 μL, 52 mg, 0.5 mmol), and 2-bromodecane (3.4 mL, 16 mmol). The flask was heated to 100° C. for 2 hours. Filtration and titration resulted in a [1.00 M] solution of 1-octylethylzinc bromide.

### Synthesis of (4-Methylpentan-2-yl)zinc Bromide

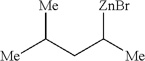

According to the general procedure, a 25 mL Schlenk flask was charged with zinc dust (1.83 g, 28 mmol), dioxane (7 mL), trimethylsilyl chloride (50 μL, 43 mg, 0.4 mmol), and 2-bromo-4-methylpentane (2.29 g, 14 mmol). The flask was heated to 100° C. for 2 hours. Filtration and titration resulted in a [0.91 M] solution of (4-methylpentan-2-yl)zinc bromide in dioxane.

### Synthesis of (1S,4R)-Bicyclo[2.2.2.1]heptan-2-ylzinc Bromide

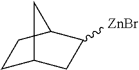

According to the general procedure, a 25 mL Schlenk flask was charged with zinc dust (2.6 g, 40 mmol), dioxane (10 mL), trimethylsilyl chloride (80 μL, 65 mg, 0.6 mmol), and 2-exo-bromonorbornane (2.6 mL, 3.5 g, 20 mmol). The flask was heated to 100° C. for 3 hours. Filtration and titration resulted in a [1.23 M] solution of (1S,4R)-bicyclo[2.2.1]heptan-2-ylzinc bromide.

### Synthesis of α-Methylbenzylzinc Bromide

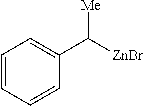

A 50 mL Schlenk flask equipped with a stirbar and rubber septum attached to a double manifold (with cold trap) was charged with titrated, [0.38 M] α-methylbenzylzinc bromide (Aldrich) in THF (25 mL, 9.5 mmol) and dioxane (8 mL). Solvent was removed in vacuo (26° C./0.3 mm Hg) until total volume was reduced to approximately 2-3 mL (solution became viscous). Dioxane (12 mL) was added and solvents were removed again in vacuo (26° C./0.2 mm Hg) until total volume was reduced to approximately 2-3 mL (viscous solution). Dioxane (8 mL) was added to afford a total volume of approximately 10 mL. Filtration via cannula to a Schlenk bomb and titration resulted in a [0.82 M] solution of α-methylbenzylzinc bromide in dioxane. The solvent exchange setup diagram is depicted in FIG. 2.

### Synthesis of (4-Phenylbutan-2-yl)zinc Bromide

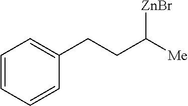

According to the general procedure, a 10 mL Schlenk flask was charged with zinc dust (1.3 g, 20 mmol), dioxane (5 mL), trimethylsilyl chloride (40 μL, 33 mg 0.3 mmol), and 2-bromo-4-phenylbutane (2.1 g, 10 mmol). The flask was heated to 100° C. for 2 hours. Filtration and titration resulted in a [1.32 M] solution of (4-phenylbutan-2-yl)zinc bromide.

### Synthesis of (4-(4-(Ethoxycarbonyl)phenyl)butan-2yl)zinc Bromide

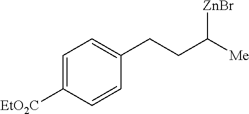

According to the general procedure, a 10 mL Schlenk flask was charged with zinc dust (1.3 g, 20 mmol), dioxane (6 mL), trimethylsilyl chloride (100 μL, 86 mg, 0.8 mmol), and ethyl 4-(3-bromobutyl)benzoate (2.85 g, 10 mmol). The flask was heated to 100° C. for 2 hours. Filtration and titration resulted in a [1.09 M] solution of (4-(4-(ethoxycarbonyl)phenyl)butan-2yl)zinc bromide in dioxane.

### Synthesis of (4-(4-Methoxyphenyl)butan-2yl)zinc Bromide

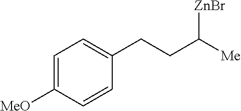

According to the general procedure, a 10 mL Schlenk flask was charged with zinc dust (1.3 g, 20 mmol), dioxane (5 mL), trimethylsilyl chloride (40 μL, 33 mg, 0.3 mmol), and 1-(3-bromobutyl)-4-methoxybenzene (2.4 g, 10 mmol). The flask was heated to 100° C. for 2 hours. Filtration and titration resulted in a [1.26 M] solution of (4-(4-methoxyphenyl)butan-2yl)zinc bromide.

### Synthesis of (4-(4-Chlorophenyl)butan-2-yl)zinc Bromide

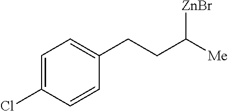

According to the general procedure, a 10 mL Schlenk flask was charged with zinc dust (1.3 g, 20 mmol), dioxane (5 mL), trimethylsilyl chloride (40 μL, 33 mg, 0.3 mmol), and 1-(3-bromobutyl)-4-chlorobenzene (2.5 g, 10 mmol). The flask was heated to 100° C. for 2 hours. Filtration and titration resulted in a [1.25 M] solution of (4-(4-chlorophenyl)butan-2-yl)zinc bromide.

### Synthesis of (4-(4-(Trifluoromethyl)phenyl)butan-2yl)zinc Bromide

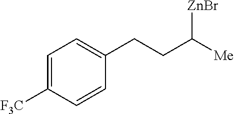

According to the general procedure, a 10 mL Schlenk flask was charged with zinc dust (1.3 g, 20 mmol), dioxane (5 mL), trimethylsilyl chloride (40 μL, 33 mg, 0.3 mmol), and 1-(3-bromobutyl)-4-(trifluoromethyl)benzene (2.82 g, 10 mmol). The flask was heated to 100° C. for 2 hours. Filtration and titration resulted in a [1.14 M] solution of (4-(4-(trifluoromethyl)phenyl)butan-2yl)zinc bromide in dioxane.

### Synthesis of (3-Methylbutan-2-yl)zinc Iodide

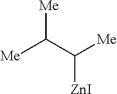

According to a modified procedure, a 10 mL Schlenk flask was charged with zinc dust (294 mg, 4.5 mmol), dioxane (1 mL), trimethylsilyl chloride (20 μL, 17 mg, 0.1 mmol), and 2-iodo-3-methylbutane (446 mg, 2.3 mmol) was added dissolved in dry dioxane (1.1 mL). The flask was heated to 50° C. for 1 hour. Filtration and titration resulted in a [1.05 M] solution of (3-methylbutan-2-yl)zinc iodide.

### Synthesis of (3,3-Dimethylbutan-2-yl)zinc Iodide

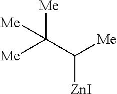

According to a modified procedure, a 10 mL Schlenk flask was charged with zinc dust (0.8 g, 12 mmol), dioxane (5 mL), trimethylsilyl chloride (50 μL, 43 mg, 0.4 mmol), and 3-iodo-2,2-dimethylbutane (1.31 g, 6 mmol). The flask was heated to 50° C. for 2 hours. Filtration and titration resulted in a [0.54 M] solution of (3,3-dimethylbutan-2-yl)zinc iodide in dioxane.

### Synthesis of Alkylmagnesium Halides

General Procedure

An oven dried round bottom flask equipped with a magnetic stirbar and rubber septum was attached to a double manifold and cooled under vacuum. The flask was backfilled with N₂, the septum removed, magnesium turnings (1.5 equiv.) and a single chip of I₂ (˜20-30 mg) were added. The septum was replaced; the flask was attached to a double manifold and purged with N₂ for 10 min. The flask was held under positive N₂ then Et₂O [3 M] was added. The solution was stirred until clarity was reached (disappearance of brown I₂ color). An initial amount of alkyl halide (˜200-400 μL) was added to start the reaction as evidenced by a minor exotherm. If reaction does not initiate, gentle warming (for example with a heating mantle) may be necessary. Once initiated, the alkyl halide was added dropwise so as to keep the mixture warm, but below full reflux. If desired, a reflux condenser may be used as well. After full addition of the alkyl halide, the flask was allowed to stir at RT for an additional 1-4 hours. The excess magnesium was allowed to settle and the mixture was filtered via cannula to a Schlenk tube. If insoluble particles persist, filtration through a 0.2 μm PTFE syringe filter was employed. Solutions were then titrated according to the literature procedure by Knochel. Titration concentrations used in the isolation runs in Section 5 may differ from those reported here. The procedures listed below reflect titrations from specific experimental runs.

### Synthesis of Isopropylmagnesium Iodide

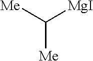

According to the general procedure, magnesium turnings (1.1 mg, 45 mmol, 1.5 equiv.), diethyl ether (10 mL), I₂ chip, and isopropyl iodide (3.0 mL, 5.1 g, 30 mmol, 1 equiv.) were combined under nitrogen and stirred for 2 hours at RT. Filtration and titration resulted in a [1.84 M] solution of isopropylmagnesium iodide.

### Synthesis of Isopropylmagnesium Bromide

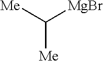

According to the general procedure, magnesium turnings (1.1 mg, 45 mmol, 1.5 equiv.), diethyl ether (10 mL), I₂ chip, and isopropyl bromide (2.8 mL, 3.69 g, 30 mmol, 1 equiv.) were combined under nitrogen and stirred for 2 hours at RT. Filtration and titration resulted in a [2.23 M] solution of isopropylmagnesium bromide.

### Synthesis of Isopropylmagnesium Chloride

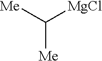

According to the general procedure, magnesium turnings (1.1 mg, 45 mmol, 1.5 equiv.), diethyl ether (10 mL), no iodine, and isopropyl chloride (2.7 mL, 2.36 g, 30 mmol) were combined under nitrogen and stirred for 4 hours at RT. Filtration and titration resulted in a [2.65 M] solution of isopropylmagnesium chloride.

### Synthesis of n-Butylmagnesium Bromide

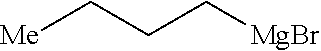

According to the general procedure, magnesium turnings (730 mg, 30 mmol), diethyl ether (7 mL), no iodine, and a solution of n-butyl bromide (2.7 mL, 3.4 g, 25 mmol) in diethyl ether (5 mL) were combined under nitrogen and stirred for 4 hours at RT. Filtration and titration resulted in a [1.93 M] solution of n-butylmagnesium bromide.

### Synthesis of 3-Pentyl magnesium Bromide

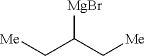

According to the general procedure, magnesium turnings (300 mg, 12 mmol), diethyl ether (3 mL), I₂ chip, and solution of 3-bromopentane (1.2 mL, 1.5 g, 10 mmol) in diethyl ether (2 mL) were combined under nitrogen and stirred for 4 hours at RT. Filtration and titration resulted in a [0.67 M] solution of 3-pentylmagnesium bromide.

### Synthesis of (1S,4R)-Bicyclo[2.2.1]heptan-2-ylmagnesium Bromide

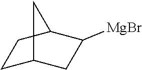

According to the general procedure, magnesium turnings (730 mg, 30 mmol, 1.5 equiv.), diethyl ether (6.7 mL), I₂ chip, and (1S,4R)-2-bromobicyclo[2.2.1]heptane (2.6 mL, 3.5 g, 20 mmol, 1 equiv.) were combined under nitrogen and stirred 3 hour at RT. Filtration and titration resulted in a [1.21 M] solution of (1S,4R)-bicyclo[2.2.1]heptan-2-ylmagnesium bromide in an exo:endo ratio of 41:59, as determined by NMR.

### Synthesis of Neopentylmagnesium Bromide

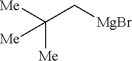

According to the general procedure, magnesium turnings (730 mg, 30 mmol), diethyl ether (7 mL), I₂ chip, and solution of neopentyl bromide (3 mL, 3.6 g, 24 mmol) in diethyl ether (5 mL). Filtration and titration resulted in a [0.95 M] solution of neopentylmagnesium bromide.

### Synthesis of (4-Phenylbutan-2-yl)magnesium Bromide

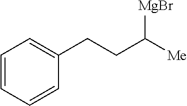

According to the general procedure, magnesium turnings (1.1 g, 45 mmol, 1.5 equiv.), I₂ chip, Et₂O (10 mL), and (3-bromobutyl)benzene (6.4 g, 30 mmol, 1 equiv.) were combined under nitrogen and stirred for 1 hour at RT. Filtration and iodometric titration resulted in a [1.34 M] solution of (4-phenylbutan-2-yl)magnesium bromide.

### Synthesis of (4-(4-Chlorophenyl)butan-2-yl)magnesium Bromide (GR9)

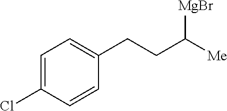

According to the general procedure, magnesium turnings (292 mg, 12 mmol, 1.2 equiv.), I₂ chip, Et₂O (3.3 mL), and 1-(3-bromobutyl)-4-chlorobenzene (2.48 g, 10 mmol, 1 equiv.) were combined under nitrogen and stirred for 2 hours at RT. Filtration and iodometric titration resulted in a [0.85 M] solution of (4-(4-chlorophenyl)butan-2-yl)magnesium bromide.

### Synthesis of (4-(4-Methoxyphenyl)butan-2-yl)magnesium Bromide

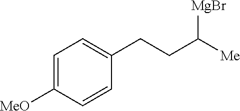

According to the general procedure, magnesium turnings (292 mg, 12 mmol, 1.2 equiv.), I₂ chip, Et₂O (3.3 mL), and 1-(3-bromobutyl)-4-methoxybenzene (2.43 g, 10 mmol, 1 equiv.) were combined under nitrogen and stirred for 2 hours at RT. Filtration and iodometric titration resulted in a [0.85 M] solution of (4-(4-methoxyphenyl)butan-2-yl)magnesium bromide.

### Synthesis of (1-Phenylethyl)magnesium Bromide)

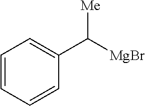

According to a modified version of the general procedure, magnesium turnings (1.1 g, 45 mmol, 1.5 equiv.), diethyl ether (10 mL), and I₂ chip were added. Once clarity of the solution was reached, the flask was cooled to 0° C. in an ice/water bath. Stirring at 0° C., (1-bromoethyl)benzene (5.6 g, 4.1 mL, 30 mmol, 1 equiv.) was added dropwise via syringe pump over ˜1 hour. After addition, the flask was allowed to stir at RT ˜3 h. Filtration and titration resulted in a [0.55 M] solution of (1-phenylethyl)magnesium bromide.

### Synthesis of Silahydrocarbons

General Procedure A

Reactions were run at [0.5 M] overall concentration based on the sum of all liquid reagents. THF quenches were performed for certain substrates due to inseparable disiloxane formed upon aqueous workup. This quench generates the more easily separated (4-iodobutoxy)silane through silyl iodide induced ring opening of THF.

An oven dried 10 mL Schlenk flask equipped with a magnetic stirbar and rubber septum was attached to a double manifold and cooled under vacuum. The flask was backfilled with N₂, the rubber septum was removed, and (DrewPhos)₂PdI₂ (0.01 equiv.) was added. The septum was replaced and the flask purged with N₂ for 10 minutes. Dioxane, triethylamine (1 equiv.), silyl iodide (2 equiv.), and alkylzinc bromide (1 equiv.) were added via syringe. The flask was then stirred at RT for the indicated time. The reaction was quenched as indicated, diluted with Et₂O (20 mL) or EtOAc (20 mL) then washed 2 times with brine (20 mL). The organic layer was dried over MgSO₄, filtered, and the solvent removed in vacuo. The crude material was purified via silica gel flash chromatography in the indicated solvent.

General Procedure B: Room Temperature Coupling

An oven dried 10 mL Schlenk flask equipped with a magnetic stirbar and rubber septum was attached to a double manifold and cooled under vacuum. The flask was backfilled with N₂, the rubber septum was removed, and (DrewPhos)₂PdI₂ (0.01 equiv.) was added. The septum was replaced and the flask purged with N₂ for 10 minutes.

Et₂O, silyl chloride (1.2 equiv.), and alkylmagnesium halide (1 equiv.) were added sequentially via syringe. The solution was then stirred at RT for 24 h. A vent needle was added and the reaction was quenched with EtOAc (3 mL) then H₂O (3 mL) via syringe. The mixture was washed 2 times with brine (20 mL) and extracted using EtOAc or Et₂O. The combined organic layer was dried over MgSO₄, filtered, and the solvent removed in vacuo. The crude material was purified via silica gel flash chromatography in the indicated solvent.

General Procedure C: 50° C. Coupling

An oven dried 10 mL Schlenk flask equipped with a magnetic stirbar and rubber septum was attached to a double manifold and cooled under vacuum. The flask was backfilled with N₂, the rubber septum was removed, and (DrewPhos)₂PdI₂ (0.01 equiv.) was added. The septum was replaced and the flask purged with N₂ for 10 minutes. Bu₂O, silyl chloride (2 equiv.), and alkylmagnesium halide (1 equiv.) were added sequentially via syringe. The solution was then stirred in an oil bathour at 50° C. for 24 h. The flask was cooled to RT, a vent needle was added and the reaction was quenched with EtOAc (3 mL) then H₂O (3 mL) via syringe. The mixture was washed 2 times with brine (20 mL) and extracted using EtOAc or Et₂O. The combined organic layer was dried over MgSO₄, filtered, and the solvent removed in vacuo. The crude material was purified via silica gel flash chromatography in the indicated solvent.

General Procedure D: Coupling Using Solid Silyl Chlorides

An oven dried 10 mL Schlenk flask equipped with a magnetic stirbar and rubber septum was attached to a double manifold and cooled under vacuum. The flask was backfilled with N₂, the rubber septum was removed, (DrewPhos)₂PdI₂ (0.01 equiv.) and silyl chloride (2 equiv.) were added. The septum was replaced and the flask purged with N₂ for 10 minutes. Bu₂O and alkylmagnesium halide (1 equiv.) were added sequentially via syringe. The solution was then stirred in an oil bathour at the indicated temperature for 24 h. The flask was cooled to RT, a vent needle was added and the reaction was quenched with EtOAc (3 mL) then H₂O (3 mL) via syringe. The mixture was washed 2 times with brine (20 mL) and extracted using EtOAc or Et₂O. The combined organic layer was dried over MgSO₄, filtered, and the solvent removed in vacuo. The crude material was purified via silica gel flash chromatography in the indicated solvent.

### Example 1—Synthesis of Compound (1)

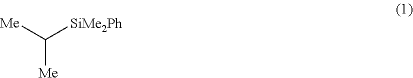

According to general procedure A, (DrewPhos)₂PdI₂ (16 mg, 10 μmol), dioxane (820 μL), triethylamine (140 μL, 1 mmol), dimethylphenylsilyl iodide (360 μL, 2 mmol), and [1.56 M] isopropylzinc iodide (640 μL, 1 mmol) were combined under N₂ and stirred at RT for 1 h. The reaction was quenched with wet EtOAc (0.5 mL) and brine (3 mL) via syringe then worked up according to general procedure B and purified via silica gel flash chromatography (hexanes) to afford compound (1) as a clear volatile oil (165.1 mg, 93%): ¹H NMR (400 MHz, CDCl₃) δ 7.59-7.45 (m, 2H), 7.44-7.31 (m, 3H), 1.02-0.92 (m, 7H), 0.25 (s, 6H); ¹³C NMR (101 MHz, CDCl₃) δ 138.7, 134.1, 128.9, 127.7, 17.7, 13.9, −5.2; ²⁹Si NMR (119 MHz, CDCl₃) δ-0.40; FTIR (cm⁻¹): 2955, 2864, 1463, 1427, 1248, 1112, 882, 831, 812, 770, 733, 699. HRMS (CI) m/z, calculated for [C₁₁H₁₈Si]⁺: 178.1178; found: 178.1179.

According to general procedure A, (DrewPhos)₂PdI₂ (16 mg, 10 μmol), dioxane (940 μL), triethylamine (140 μL, 1 mmol), dimethylphenylsilyl iodide (360 μL, 2 mmol), and [1.79 M] isopropylzinc bromide (560 μL, 1 mmol) were combined under N₂ and stirred at RT for 4 h. The reaction was quenched with wet EtOAc (0.5 mL) and brine (3 mL) via syringe then worked up according to general procedure B and purified via silica gel flash chromatography (hexanes) to afford compound (1) as a clear volatile oil (160.5 mg, 90%). NMR spectra matched previous isolation: ¹H NMR (400 MHz, CDCl₃) δ 7.57-7.45 (m, 2H), 7.40-7.32 (m, 3H), 1.07-0.86 (m, 7H), 0.25 (s, 6H); ¹³C NMR (101 MHz, CDCl₃) δ 138.7, 134.1, 128.9, 127.7, 17.7, 13.9, −5.2.

A two dram vial with stirbar (open to air) was charged with (DrewPhos)₂PdI₂ (16 mg, 10 μmol), dioxane (910 μL), triethylamine (140 μL, 1 mmol) and dimethylphenylsilyl iodide (360 μL, 2 mmol). The vial was sealed with a Teflon lined cap. While stirring, the cap was removed, [1.70 M] solution isopropylzinc iodide (590 μL, 1 mmol) was added via syringe, and the cap was replaced. Stirring at RT was continued for 1 h. The reaction was quenched by removing the cap and adding wet EtOAc (0.5 mL) and brine (3 mL) via syringe and then worked up according to general procedure B and purified via silica gel flash chromatography (hexanes) to afford compound (1) as a clear volatile oil (156.1 mg, 88%). NMR spectra matched previous isolations: ¹H NMR (400 MHz, CDCl₃) δ 7.52-7.49 (m, 2H), 7.36-7.35 (m, 3H), 0.99-0.94 (m, 7H), 0.25 (s, 6H); ¹³C NMR (101 MHz, CDCl₃) δ 138.6, 133.9, 128.7, 127.6, 17.6, 13.8, −5.3.

According to general procedure A, (DrewPhos)₂PdI₂ (390 mg, 0.25 mmol), dioxane (21 mL), triethylamine (3.5 mL, 25 mmol), dimethylphenylsilyl iodide (9 mL, 50 mmol), and [1.52 M] isopropylzinc bromide (16.5 mL, 25 mmol) were combined under N₂ and stirred at RT for 4 h. The reaction was quenched with THF (10 mL), stirred for 15 min then worked up according to general procedure B and purified via silica gel flash chromatography (hexanes) to afford compound (1) as a clear volatile oil (4.35 g, 98%). NMR spectra matched previous isolation: ¹H NMR (400 MHz, CDCl₃) δ 7.53-7.49 (m, 2H), 7.37-7.33 (m, 3H), 0.97-0.94 (m, 7H), 0.25 (s, 6H); ¹³C NMR (101 MHz, CDCl₃) δ 138.8, 134.1, 128.9, 127.7, 17.7, 13.9, −5.2.

According to general procedure B, (DrewPhos)₂PdI₂ (16 mg, 10 μmol), Et₂O (1.36 mL), dimethylphenylsilyl chloride (200 μL, 1.2 mmol), and [2.29 M]isopropylmagnesium bromide (440 μL, 1.0 mmol) were combined under N₂ and stirred at RT for 1 h. After workup, the crude product was purified via silica gel flash chromatography (hexanes) to afford compound (1) as a clear oil (178 mg, 99%): ¹H NMR (600 MHz, CDCl₃) δ 7.55-7.50 (m, 2H), 7.39-7.33 (m, 3H), 1.01-0.94 (m, 7H), 0.26 (s, 6H). ¹³C NMR (151 MHz, CDCl₃) δ 138.8, 134.1, 128.9, 127.8, 17.7, 13.9, −5.2. ²⁹Si NMR (119 MHz, CDCl₃) δ 0.4.

### Example 2—Synthesis of Compound (2)

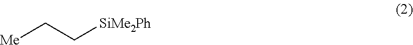

According to general procedure A, (DrewPhos)₂PdI₂ (16 mg, 10 μmol), dioxane (1.00 mL), triethylamine (140 μL, 1 mmol), dimethylphenylsilyl iodide (360 μL, 2 mmol), and [2.25 M] n-propylzinc iodide (440 μL, 1 mmol) were combined under N₂ and stirred at RT for 1 h. The reaction was quenched with wet EtOAc (0.5 mL) and brine (3 mL) via syringe then worked up according to general procedure B and purified via silica gel flash chromatography (hexanes) to afford compound (2) as a clear very volatile oil (169.5 mg, 96%): ¹H NMR (400 MHz, CDCl₃) δ 7.56-7.49 (m, 2H), 7.39-7.31 (m, 3H), 1.42-1.31 (m, 2H), 0.96 (t, J=7.2 Hz, 3H), 0.79-0.72 (m, 2H), 0.26 (s, 6H); ¹³C NMR (101 MHz, CDCl₃) δ 139.9, 133.7, 128.9, 127.8, 18.51, 18.48, 17.6, −2.8; ²⁹Si NMR (119 MHz, CDCl₃) δ-3.37; FTIR (cm⁻¹): 2955, 2868, 1427, 1248, 1114, 1065, 997, 882, 834, 767, 727, 699. HRMS (CI) m/z, calculated for [C₁₀H₁₅Si]⁺: 163.0943; found: 163.0941.

### Example 3—Synthesis of Compound (3)

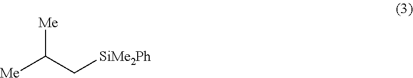

According to general procedure A, (DrewPhos)₂PdI₂ (16 mg, 10 μmol), dioxane (900 μL), triethylamine (140 μL, 1 mmol), dimethylphenylsilyl iodide (360 μL, 2 mmol), and [1.59 M] isobutylzinc iodide (640 μL, 1 mmol) were combined under N₂ and stirred at RT for 1 h. The reaction was quenched with wet EtOAc (0.5 mL) and brine (3 mL) via syringe then worked up according to general procedure B and purified via silica gel flash chromatography (hexanes) to afford compound (3) as a clear volatile oil (187.0 mg, 95%). NMR spectra matched previous isolation: ¹H NMR (400 MHz, CDCl₃) δ 7.58-7.44 (m, 2H), 7.43-7.31 (m, 3H), 1.77 (dh, J=13.3, 6.6 Hz, 1H), 0.90 (d, J=6.6 Hz, 6H), 0.77 (d, J=6.9 Hz, 2H), 0.29 (s, 6H); ¹³C NMR (101 MHz, CDCl₃) δ 140.4, 133.7, 128.8, 127.8, 26.50, 26.48, 25.1, −1.9.

According to general procedure A, (DrewPhos)₂PdI₂ (16 mg, 10 μmol), dioxane (800 μL), triethylamine (140 μL, 1 mmol), dimethylphenylsilyl iodide (360 μL, 2 mmol), and [1.34 M] isobutylzinc bromide (750 μL, 1 mmol) were combined under N₂ and stirred at RT for 4 h. The reaction was quenched with wet EtOAc (0.5 mL) and brine (3 mL) via syringe then worked up according to general procedure B and purified via silica gel flash chromatography (hexanes) to afford compound 3 as a clear volatile oil (183.3 mg, 95%): ¹H NMR (400 MHz, CDCl₃) δ 7.55-7.50 (m, 2H), 7.38-7.32 (m, 3H), 1.77 (dh, J=13.3, 6.7 Hz, 1H), 0.91 (d, J=6.6 Hz, 6H), 0.78 (d, J=6.9 Hz, 2H), 0.29 (s, 6H); ¹³C NMR (101 MHz, CDCl₃) δ 140.3, 133.7, 128.8, 127.8, 26.50, 26.48, 25.1, −1.9; ²⁹Si NMR (119 MHz, CDCl₃) δ-4.17; FTIR (cm⁻¹): 2953, 2893, 2361, 2338, 1248, 1112, 838, 812, 790, 698. HRMS (CI) m/z, calculated for [C₁₂H₁₉Si]⁺: 191.1256; found: 191.1253.

### Example 4—Synthesis of Compound (4)

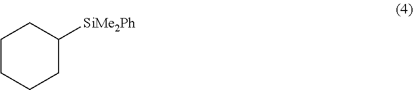

According to general procedure A, (DrewPhos)₂PdI₂ (16 mg, 10 μmol), dioxane (440 μL), triethylamine (140 μL, 1 mmol), dimethylphenylsilyl iodide (360 μL, 2 mmol), and [0.97 M] cyclohexylzinc iodide (1.00 mL, 0.97 mmol) were combined under N₂ and stirred at RT for 1 h. The reaction was quenched with wet EtOAc (0.5 mL) and brine (3 mL) via syringe then worked up according to general procedure B and purified via silica gel flash chromatography (hexanes) to afford compound (4) as a clear oil (205.6 mg, 97%): ¹H NMR (400 MHz, CDCl₃) δ 7.52-7.47 (m, 2H), 7.40-7.32 (m, 3H), 1.75-1.61 (m, 5H), 1.27-1.02 (m, 5H), 0.84-0.73 (m, 1H), 0.24 (s, 6H); ¹³C NMR (101 MHz, CDCl₃) δ 138.8, 134.1, 128.8, 127.7, 28.2, 27.5, 27.0, 25.9, −5.1; ²⁹Si NMR (119 MHz, CDCl₃) δ-2.20; FTIR (cm⁻¹): 2919, 2846, 1446, 1427, 1247, 1112, 850, 834, 818, 770, 699. HRMS (CI) m/z, calculated for [C₁₄H₂₂Si]⁺: 218.1491; found: 218.1486.

### Example 5—Synthesis of Compound (5)

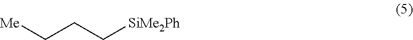

According to general procedure A, (DrewPhos)₂PdI₂ (16 mg, 10 μmol), dioxane (900 μL), triethylamine (140 μL, 1 mmol), dimethylphenylsilyl iodide (360 μL, 2 mmol), and [1.60 M] n-butylzinc bromide (630 μL, 1 mmol) were combined under N₂ and stirred at RT for 4 h. The reaction was quenched with wet EtOAc (0.5 mL) and brine (3 mL) via syringe then worked up according to general procedure B and purified via silica gel flash chromatography (hexanes) to afford compound (5) as a clear oil (175.1 mg, 91%): ¹H NMR (400 MHz, CDCl₃) δ 7.55-7.49 (m, 2H), 7.39-7.33 (m, 3H), 1.37-1.26 (m, 4H), 0.87 (t, J=6.9 Hz, 3H), 0.80-0.73 (m, 2H), 0.26 (s, 6H); ¹³C NMR (101 MHz, CDCl₃) δ 139.9, 133.7, 128.9, 127.8, 26.7, 26.2, 15.6, 13.9, −2.9; ²⁹Si NMR (119 MHz, CDCl₃) δ-3.08; FTIR (cm⁻¹): 2956, 2922, 2872, 1427, 1248, 1113, 887, 837, 779, 727, 699. HRMS (CI) m/z, calculated for [C₁H₁₇Si]⁺: 177.1100; found: 177.1102.

According to general procedure B, (DrewPhos)₂PdI₂ (16 mg, 10 μmol), Et₂O (1.32 mL), dimethylphenylsilyl chloride (200 μL, 1.2 mmol), and [2.1 M] n-butylmagnesium bromide (480 μL, 1.0 mmol) were combined under N₂ and stirred at RT for 1 h. After workup, the crude product was purified via silica gel flash chromatography (hexanes) to afford compound (3) as a clear oil (192 mg, 99%): ¹H NMR (600 MHz, CDCl₃) δ 7.55-7.48 (m, 2H), 7.39-7.32 (m, 3H), 1.37-1.26 (m, 4H), 0.87 (t, J=6.9 Hz, 3H), 0.78-0.73 (m, 2H), 0.26 (s, 6H). ¹³C NMR (151 MHz, CDCl₃) δ 139.9, 133.7, 128.9, 127.8, 26.7, 26.2, 15.6, 13.9, −2.9. ²⁹Si NMR (119 MHz, CDCl₃) δ −3.1.

### Example 6—Synthesis of Compound (6)

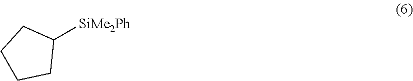

According to general procedure A, (DrewPhos)₂PdI₂ 16 mg, 10 μmol), dioxane (380 μL), triethylamine (140 μL, 1 mmol), dimethylphenylsilyl iodide (360 μL, 2 mmol), and [0.89 M] cyclopentylzinc bromide (1.1 mL, 1 mmol) were combined under N₂ and stirred at RT for 4 h. The reaction was quenched with wet Et₂O (3 mL) and H₂O (3 mL) via syringe then worked up according to general procedure B and purified via silica gel flash chromatography (hexanes) to afford compound (6) as a clear oil (197 mg, 97%): ¹H NMR (600 MHz, CDCl₃) δ 7.55-7.50 (m, 2H), 7.36-7.33 (m, 3H), 1.80-1.73 (m, 2H), 1.59-1.46 (m, 4H), 1.36-1.25 (m, 2H), 1.11 (tt, J=8.4 Hz, 1H), 0.25 (s, 6H); ¹³C NMR (151 MHz, CDCl₃) δ 139.4, 133.9, 128.7, 127.6, 28.2, 27.0, 25.5, −4.5; ²⁹Si NMR (119 MHz, CDCl₃) δ −2.01; FTIR (cm⁻¹): 3068, 2950, 2862, 1427, 1248, 1114, 827, 811, 699, 415. HRMS (CI) m/z, calculated for [C₁₃H₂₀Si]⁺: 204.1334; found: 204.1337.

According to general procedure B, (DrewPhos)₂PdI₂ (16 mg, 10 μmol), diethyl ether (1.24 mL), dimethylphenylsilyl chloride (200 μL, 1.2 mmol), and [1.77 M]cyclopentylmagnesium bromide (0.56 mL, 1.0 mmol) were combined under N₂ and stirred at RT for 24 h. After workup, crude product was purified via silica gel flash chromatography (hexanes) to afford compound (6) as a clear oil (200 mg, 99%): ¹H NMR (600 MHz, CDCl₃) δ 7.56-7.52 (m, 2H), 7.40-7.32 (m, 3H), 1.83-1.72 (m, 2H), 1.58-1.49 (m, 4H), 1.39-1.27 (m, 2H), 1.13 (tt, J=10.8, 8.2 Hz, 1H), 0.26 (s, 6H). ¹³C NMR (151 MHz, CDCl₃) δ 139.5, 134.0, 128.8, 127.8, 28.4, 27.2, 25.6, −4.3. ²⁹Si NMR (119 MHz, CDCl₃) δ-2.0.

### Example 7—Synthesis of Compound (7)

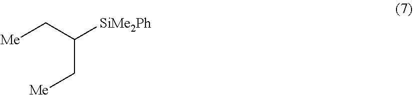

According to general procedure A, (DrewPhos)₂PdI₂ (16 mg, 10 μmol), dioxane (760 μL), triethylamine (140 μL, 1 mmol), dimethylphenylsilyl iodide (360 μL, 2 mmol), and [1.35 M] pentan-3-ylzinc bromide (740 μL, 1 mmol) were combined under N₂ and stirred at RT for 4 h. The reaction was quenched with wet Et₂O (3 mL) and H₂O (3 mL) via syringe and worked up according to general procedure B and purified via silica gel flash chromatography (hexanes) to afford compound 7 as a clear oil (192 mg, 93%): ¹H NMR (600 MHz, CDCl₃) δ 7.53-7.49 (m, 2H), 7.36-7.32 (m, 3H), 1.57-1.47 (m, 2H), 1.36 (dp, J=14.7, 7.4 Hz, 2H), 0.87 (t, J=7.4 Hz, 6H), 0.74-0.68 (m, 1H), 0.28 (s, 6H); ¹³C NMR (151 MHz, CDCl₃) δ 139.7, 133.8, 128.6, 127.6, 28.9, 21.7, 13.7, −3.6; ²⁹Si NMR (119 MHz, CDCl₃) δ −1.04; FTIR (cm⁻¹):3069, 2959, 2871, 1427, 1248, 1029, 831, 810, 700, 471. HRMS (CI) m/z, calculated for [C₁₃H₂₂Si]⁺: 206.1491; found: 206.1495.

### Example 8—Synthesis of Compound (8)

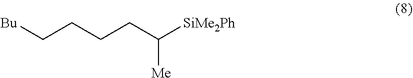

According to general procedure A, (DrewPhos)₂PdI₂ (16 mg, 10 μmol), dioxane (500 μL), triethylamine (140 μL, 1 mmol), dimethylphenylsilyl iodide (360 μL, 2 mmol), and [1.00 M] 1-octylethylzinc bromide (1 mL, 1 mmol) were combined under N₂ and stirred at RT for 4 h. The reaction was quenched with dry THF (405 μL, 5 equiv, 5 mmol) via syringe and allowed to stir 15 minutes at RT then worked up according to general procedure B and purified via silica gel flash chromatography (hexanes) to afford compound (8) as a clear oil (261 mg, 94%): ¹H NMR (600 MHz, CDCl₃) δ 7.51-7.48 (m, 2H), 7.36-7.31 (m, 3H), 1.49-1.36 (m, 2H), 1.33-1.20 (m, 9H), 1.19-1.13 (m, 2H), 1.13-1.06 (m, 1H), 0.92 (d, J=7.2 Hz, 3H), 0.88 (t, J=7.1 Hz, 3H), 0.86-0.80 (m, 1H), 0.24 (d, J=2.6 Hz, 6H); ¹³C NMR (151 MHz, CDCl₃) δ 139.1, 134.1, 128.8, 127.7, 32.1, 31.7, 29.8, 29.7, 29.5, 28.7, 22.8, 19.2, 14.3, 14.2, −4.7; ²⁹Si NMR (119 MHz, CDCl₃) δ −0.17; FTIR (cm⁻¹): 3069, 2955, 2924, 2853, 1466, 1427, 1248, 1112, 832, 813, 770, 733, 700. HRMS (CI) m/z, calculated for [C₁₈H₃₁Si]⁺: 275.2195; found: 275.2206.

### Example 9—Synthesis of Compound (9)

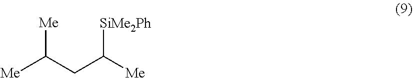

According to general procedure A, (DrewPhos)₂PdI₂ (16 mg, 10 μmol), dioxane (400 μL), triethylamine (140 μL, 1 mmol), dimethylphenylsilyl iodide (360 μL, 2 mmol), and [0.91 M] (4-methylpentan-2-yl)zinc bromide in dioxane (1.10 mL, 1 mmol) were combined under N₂ and stirred at RT for 15 h. The reaction was quenched with wet EtOAc (0.5 mL) and brine (3 mL) via syringe and worked up according to general procedure B and purified via silica gel flash chromatography (hexanes) to afford compound (9) as a clear volatile oil (170.1 mg, 77%): ¹H NMR (600 MHz, CDCl₃) δ 7.52-7.49 (m, 2H), 7.37-7.33 (m, 3H), 1.67 (ttd, J=13.2, 6.6, 4.4 Hz, 1H), 1.16 (ddd, 2=13.4, 9.7, 3.6 Hz, 1H), 1.09 (ddd, J=13.5, 10.8, 4.4 Hz, 1H), 1.00-0.94 (m, 1H), 0.90 (d, J=7.0 Hz, 3H), 0.86 (d, J=6.6 Hz, 3H), 0.79 (d, J=6.5 Hz, 3H), 0.25 (s, 3H), 0.24 (s, 3H); ¹³C NMR (151 MHz, CDCl₃) δ 138.9, 134.1, 128.8, 127.7, 40.9, 25.5, 24.1, 21.1, 16.5, 14.0, −4.8, −4.9; ²⁹Si NMR (119 MHz, CDCl₃) (0.16; FTIR (cm-1): 2954, 2900, 2867, 1248, 1112, 830, 767, 733, 699. HRMS (CI) m/z, calculated for [C₁₃H₂₁Si]⁺: 205.1413; found: 205.1419.

### Example 10—Synthesis of Compounds (10-exo) and (10-endo)

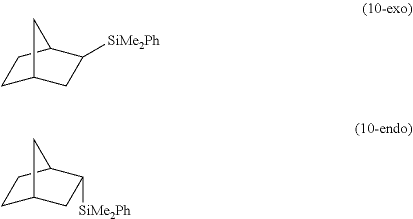

According to general procedure A, (DrewPhos)₂PdI₂ (16 mg, 10 μmol), dioxane (690 μL), triethylamine (140 μL, 1 mmol), dimethylphenylsilyl iodide (360 μL, 2 mmol), and [1.23 M] (1S,4R)-bicyclo[2.2.1]heptan-2ylzinc bromide (810 μL, 1 mmol) were combined under N₂ and stirred at RT for 4 h. The reaction was quenched with wet Et₂O (3 mL) and H₂O (3 mL) via syringe and worked up according to general procedure B and purified via silica gel flash chromatography (hexanes) to afford compounds (10-exo) and (10-endo) as an inseparable mixture of exo:endo (80:20) diastereomers as a clear oil (230 mg, 99%). Useful diagnostic peaks for each compound are listed: (10-exo): ¹H NMR (600 MHz, CDCl₃) δ 2.21 (dd, J=3.7, 2.0 Hz, 2H), 1.06-1.05 (m, 2H), 0.84-0.78 (m, 1H), 0.24 (s, 3H), 0.22 (s, 3H); ¹³C NMR (151 MHz, CDCl₃) δ 139.6, 134.1, 128.8, 127.8, 38.1, 37.9, 37.1, 34.5, 32.9, 29.1, 28.8, −3.9, −3.9; ²⁹Si NMR (119 MHz, CDCl₃) δ −3.23. (10-endo): ¹H NMR (600 MHz, CDCl₃) δ 2.33-2.25 (m, 2H), 1.78-1.69 (m, 1H), 1.03-0.98 (m, 1H), 0.31 (s, 3H), 0.29 (s, 3H); ¹³C NMR (151 MHz, CDCl₃) δ 140.4, 133.9, 128.7, 127.8, 41.9, 39.8, 37.3, 32.0, 30.0, 28.6, 27.6, −2.7, −2.9; ²⁹Si NMR (119 MHz, CDCl₃) δ −2.81.

According to general procedure B, (DrewPhos)₂PdI₂ 16 mg, 10 μmol), Et₂O (970 μL), dimethylphenylsilyl chloride (200 μL, 1.2 mmol), and [1.21 M] (1S,4R)-bicyclo[2.2.1]heptan-2-ylmagnesium bromide (830 μL, 1.0 mmol) were combined under N₂ and stirred at RT for 24 h. After workup, crude product was purified via silica gel flash chromatography (hexanes) to afford compounds (10-exo) and (10-endo) as an inseparable mixture of exo:endo (73:27) diastereomers as a clear oil (150 mg, 65%). Useful diagnostic peaks for each compound are listed: [symbol] (10-exo): ¹H NMR (600 MHz, CDCl₃) δ 2.22-2.20 (m, 2H), 1.06-1.05 (m, 2H), 0.83-0.79 (m, 1H), 0.24 (s, 3H), 0.22 (s, 3H), ¹³C NMR (151 MHz, CDCl₃) δ 139.5, 134.0, 128.8, 127.8, 38.1, 37.9, 37.1, 34.5, 32.9, 29.0, 28.7, −3.9, −3.9, ²⁹Si NMR (119 MHz, CDCl₃) δ-3.20. (10-endo): ¹H NMR (600 MHz, CDCl₃) δ 2.31 (s, 1H), 2.27 (t, J=4.3 Hz, 1H), 1.77-1.70 (m, 1H), 1.02 (tdd, J=11.0, 4.9, 2.0 Hz, 1H), 0.31 (s, 3H), 0.28 (s, 3H), ¹³C NMR (151 MHz, CDCl₃) δ 140.4, 133.9, 128.7, 127.8, 41.9, 39.7, 37.3, 32.0, 30.0, 28.5, 27.6, −2.7, −3.0, ²⁹Si NMR (119 MHz, CDCl₃) δ −2.78.

### Example 11—Synthesis of Compound (11)

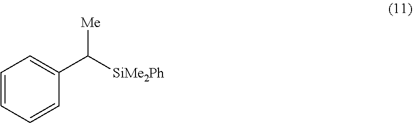

According to general procedure A, (DrewPhos)₂PdI₂ (16 mg, 10 μmol), dioxane (260 μL), triethylamine (140 μL, 1 mmol), dimethylphenylsilyl iodide (360 μL, 2 mmol), and [0.80 M] α-methylbenzylzinc bromide in dioxane (1.25 mL, 1 mmol) were combined under N₂ and stirred at RT for 16 h. The reaction was quenched with THF (0.4 mL), stirred for 15 min, and then wet EtOAc (0.5 mL) and brine (3 mL) were added via syringe and worked up according to general procedure B and purified via silica gel flash chromatography (hexanes) to afford 233 mg of mixture: compound (11), DL-2,3-diphenylbutane, meso-2,3-diphenylbutane, and (PhMe₂Si)₂O in a relative ratio 78:8:5:9. This mixture was purified by reverse phase chromatography on Biotage instrument using SNAP Ultra C_{18 120} g column (50:50 MeCN:H₂O to 80:20 MeCN:H₂O linear gradient) to obtain compound (11) as a colorless oil (171.1 mg, 71%): ¹H NMR (600 MHz, CDCl₃) δ 7.43-7.29 (m, 5H), 7.20 (t, J=7.7 Hz, 2H), 7.09 (t, J=7.3 Hz, 1H), 6.95 (d, J=7.3 Hz, 2H), 2.39 (q, J=7.5 Hz, 1H), 1.35 (d, J=7.5 Hz, 3H), 0.25 (s, 3H), 0.21 (s, 3H); ¹³C NMR (151 MHz, CDCl₃) δ 145.4, 137.8, 134.3, 129.1, 128.1, 127.7, 127.5, 124.6, 29.7, 15.3, −4.2, −5.3; ²⁹Si NMR (119 MHz, CDCl₃) δ −1.06; FTIR (cm⁻¹): 3023, 2957, 2870, 1495, 1450, 1427, 1248, 1112, 833, 817, 775, 735, 699. HRMS (CI) m/z, calculated for [C₁₆H₂₀Si]⁺: 240.1334; found: 240.1345.

According to general procedure B, (DrewPhos)₂PdI₂ 16 mg, 10 μmol), Et₂O (100 μL), dimethylphenylsilyl chloride (200 μL, 1.2 mmol), and [0.55 M] (1-phenylethyl)magnesium bromide (1.8 mL, 1.0 mmol) were combined under N₂ and stirred at RT for 24 h. After workup, crude product was purified via silica gel flash chromatography (hexanes) then by reverse phase chromatography on C₁₈ modified silica (gradient from acetonitrile:water=50:50 to acetonitrile:water=75:25) to afford compound (11) as a clear oil (129 mg, 54%): ¹H NMR (600 MHz, CDCl₃) δ 7.40-7.30 (m, 5H), 7.19 (t, J=7.6 Hz, 2H), 7.08 (t, J=7.3 Hz, 1H), 6.94 (d, J=7.2 Hz, 2H), 2.38 (q, J=7.5 Hz, 1H), 1.33 (d, J=7.5 Hz, 3H), 0.24 (s, 3H), 0.19 (s, 3H), ¹³C NMR (151 MHz, CDCl₃) δ 145.2, 137.5, 134.1, 129.0, 127.9, 127.5, 127.3, 124.4, 29.5, 15.1, −4.4, −5.5, ²⁹Si NMR (119 MHz, CDCl₃) δ −1.03.

### Example 12—Synthesis of Compound (12)

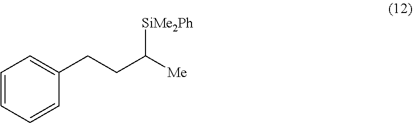

According to general procedure A, (DrewPhos)₂PdI₂ (16 mg, 10 μmol), dioxane (745 μL), triethylamine (140 μL, 1 mmol), dimethylphenylsilyl iodide (360 μL, 2 mmol), and [1.32 M] (4-phenylbutan-2-yl)zinc bromide (760 μL, 1 mmol) were combined under N₂ and stirred at RT for 4 h. The reaction was quenched with dry THF (405 μL, 5 equiv, 5 mmol) via syringe and allowed to stir 15 minutes at RT then worked up according to general procedure B and purified via silica gel flash chromatography (hexanes) to afford compound (12) as a clear oil (267 mg, 99%): ¹H NMR (600 MHz, CD₂Cl₂) δ 7.49-7.46 (m, 2H), 7.36-7.30 (m, 3H), 7.24 (t, J=7.6 Hz, 2H), 7.14 (t, J=7.4 Hz, 1H), 7.11 (d, J=7.4 Hz, 2H), 2.76 (ddd, J=14.6, 10.4, 4.9 Hz, 1H), 2.46 (ddd, J=13.5, 10.1, 6.7 Hz, 1H), 1.79 (dddd, J=13.7, 10.3, 6.6, 3.5 Hz, 1H), 1.44-1.36 (m, 1H), 1.02 (d, J=7.3 Hz, 3H), 0.92 (ddp, J=11.2, 7.3, 3.7 Hz, 1H), 0.26 (s, 3H), 0.25 (s, 3H); ¹³C NMR (151 MHz, CDCl₃) δ 143.0, 138.6, 134.1, 128.9, 128.6, 128.4, 127.8, 125.7, 35.0, 33.9, 19.0, 14.1, −4.6, −4.8; ²⁹Si NMR (119 MHz, CDCl₃) δ −0.08; FTIR (cm⁻¹): 3067, 3025, 2953, 2864, 1454, 1427, 1248, 1112, 833, 812, 772, 699. HRMS (CI) m/z, calculated for [C₁₃H₂₂Si]⁺: 253.1413; found: 253.1403.

According to general procedure B, (DrewPhos)₂PdI₂ (16 mg, 10 μmol), diethyl ether (1.1 mL), dimethylphenylsilyl chloride (200 μL, 1.2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes gradient to hexanes:dichloromethane=95:5) to afford compound (12) as a clear oil (264 mg, 98%): ¹H NMR (600 MHz, CD₂Cl₂) δ 7.50-7.47 (m, 2H), 7.37-7.31 (m, 3H), 7.24 (t, J=7.5 Hz, 2H), 7.17-7.13 (m, 1H), 7.11 (d, J=7.5 Hz, 2H), 2.76 (ddd, J=14.0, 10.4, 4.9 Hz, 1H), 2.46 (ddd, J=13.6, 10.1, 6.7 Hz, 1H), 1.79 (dddd, J=13.7, 10.3, 6.7, 3.6 Hz, 1H), 1.41 (dtd, J=13.6, 10.3, 4.9 Hz, 1H), 1.02 (d, J=7.2 Hz, 3H), 0.96-0.89 (m, 1H), 0.26 (s, 3H), 0.25 (s, 3H), ¹³C NMR (151 MHz, CDCl₃) δ 143.0, 138.7, 134.1, 128.9, 128.6, 128.4, 127.8, 125.7, 35.0, 33.9, 19.0, 14.1, −4.6, −4.8, ²⁹Si NMR (119 MHz, CDCl₃) δ-0.05.

### Example 13—Synthesis of Compound (13)

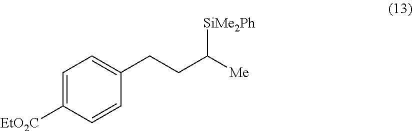

According to general procedure A, (DrewPhos)₂PdI₂ (16 mg, 10 μmol), dioxane (580 μL), triethylamine (140 μL, 1 mmol), dimethylphenylsilyl iodide (360 μL, 2 mmol), and [1.09 M] 4-(4-(ethoxycarbonyl)phenyl)butan-2yl)zinc bromide (920 μL, 1 mmol) were combined under N₂ and stirred at RT for 4 h. The reaction was quenched with wet EtOAc (0.5 mL) and brine (3 mL) via syringe and worked up according to general procedure B and purified via silica gel flash chromatography (hexanes:dichloromethane=90:10 gradient to hexanes:dichloromethane=80:20) and product dried (50° C./0.1 mmHg) for 43 h to afford compound (13) as a clear oil (276.1 mg, 81%): ¹H NMR (600 MHz, CDCl₃) δ 7.94 (d, J=8.2 Hz, 2H), 7.49-7.43 (m, 2H), 7.39-7.30 (m, 3H), 7.16 (d, J=8.2 Hz, 2H), 4.37 (q, J=7.1 Hz, 2H), 2.80 (ddd, J=14.3, 9.9, 4.9 Hz, 1H), 2.52 (ddd, J=13.6, 9.7, 7.0 Hz, 1H), 1.80 (dddd, J=13.5, 10.2, 7.0, 3.5 Hz, 1H), 1.48-1.39 (m, 1H), 1.39 (t, J=7.1 Hz, 3H), 1.02 (d, J=7.2 Hz, 3H), 0.89 (dtq, J=14.9, 7.6, 3.4 Hz, 1H), 0.26 (s, 3H), 0.25 (s, 3H); ¹³C NMR (101 MHz, CDCl₃) δ 166.8, 148.4, 138.4, 134.0, 129.7, 129.0, 128.5, 128.0, 127.8, 60.9, 34.9, 33.5, 18.8, 14.5, 14.0, −4.6, −5.0; ²⁹Si NMR (119 MHz, CDCl₃) δ-0.04; FTIR (cm⁻¹): 2954, 2864, 2361, 2340, 1427, 1718, 1610, 1275, 1248, 1107, 1021, 833, 701. HRMS (CI) m/z, calculated for [C₂₁H₂₉O₂Si]: 341.1937; found: 341.1926.

### Example 14—Synthesis of Compound (14)

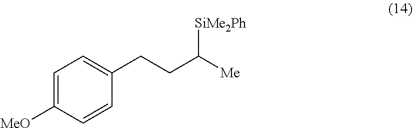

According to general procedure A, (DrewPhos)₂PdI₂ (16 mg, 10 μmol), dioxane (710 μL), triethylamine (140 μL, 1 mmol), dimethylphenylsilyl iodide (360 μL, 2 mmol), and [1.26 M] (4-(4-methoxyphenyl)butan-2yl)zinc bromide (795 μL, 1 mmol) were combined under N₂ and stirred at RT for 4 h. The reaction was quenched with wet Et₂O (3 mL) and H₂O (3 mL) via syringe and worked up according to general procedure B and purified via silica gel flash chromatography (hexanes:DCM=85:15) to afford compound (14) as a clear oil (257 mg, 86%): ¹H NMR (600 MHz, CDCl₃) δ 7.50-7.44 (m, 2H), 7.38-7.30 (m, 3H), 7.03 (d, J=8.5 Hz, 2H), 6.81 (d, J=8.6 Hz, 2H), 3.79 (s, 3H), 2.71 (ddd, J=14.4, 10.2, 4.8 Hz, 1H), 2.41 (ddd, J=13.7, 9.9, 6.9 Hz, 1H), 1.82-1.73 (m, 1H), 1.42-1.34 (m, 1H), 1.01 (d, J=7.3 Hz, 3H), 0.94-0.85 (m, 1H), 0.25 (s, 3H), 0.24 (s, 3H); ¹³C NMR (151 MHz, CDCl₃) δ 157.8, 138.7, 135.1, 134.1, 129.4, 128.9, 127.8, 113.9, 55.4, 34.08, 34.07, 18.9, 14.1, −4.6, −4.8; ²⁹Si NMR (119 MHz, CDCl₃) δ-0.08; FTIR (cm⁻¹): 3068, 2998, 2952, 2864, 1612, 1512, 1246, 1177, 1113, 1038, 816, 771, 735, 702. HRMS (CI) m/z, calculated for [C₁₉H₂₆OSi]⁺: 298.1753; found: 298.1741.

According to procedure B, (DrewPhos)₂PdI₂ (16 mg, 10 μmol), diethyl ether (620 μL), dimethylphenylsilyl chloride (200 μL, 1.2 mmol), and [0.85 M] (4-(4-methoxyphenyl)butan-2-yl)magnesium bromide (1.18 mL, 1.0 mmol) were combined under N₂ and stirred at RT for 24 h. After workup, crude product was purified via silica gel flash chromatography (hexanes gradient to hexanes:dichloromethane=90:10) to afford compound (14) as a clear oil (283 mg, 95%): ¹H NMR (600 MHz, CD₂Cl₂) δ 7.50-7.46 (m, 2H), 7.36-7.31 (m, 3H), 7.02 (d, J=8.6 Hz, 2H), 6.78 (d, 3=8.6 Hz, 2H), 3.75 (s, 3H), 2.70 (ddd, J=14.5, 10.2, 4.9 Hz, 1H), 2.40 (ddd, J=13.6, 10.0, 6.8 Hz, 1H), 1.74 (dddd, J=13.6, 10.2, 6.8, 3.5 Hz, 1H), 1.40-1.33 (m, 1H), 1.00 (d, J=7.3 Hz, 3H), 0.90 (dqd, J=11.0, 7.6, 7.2, 3.5 Hz, 1H), 0.25 (s, 3H), 0.24 (s, 3H), ¹³C NMR (151 MHz, CD₂Cl₂) δ 158.3, 139.2, 135.5, 134.5, 129.8, 129.3, 128.1, 114.1, 55.7, 34.6, 34.4, 19.3, 14.3, −4.5, −4.7, ²⁹Si NMR (119 MHz, CDCl₃) δ-0.17.

### Example 15—Synthesis of Compound (15)

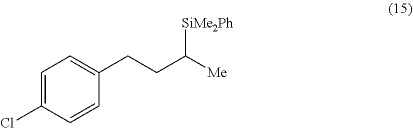

According to general procedure A, (DrewPhos)₂PdI₂ (16 mg, 10 μmol), dioxane (700 μL), triethylamine (140 μL, 1 mmol), dimethylphenylsilyl iodide (360 μL, 2 mmol), and [1.25 M] (4-(4-chlorophenyl)butan-2-yl)zinc bromide (800 μL, 1 mmol) were combined under N₂ and stirred at RT for 4 h. The reaction was quenched with dry THF (405 μL, 5 equiv, 5 mmol) via syringe and allowed to stir 15 minutes at RT then worked up according to general procedure B and purified via silica gel flash chromatography (hexanes) to afford compound (15) as a clear oil (285 mg, 94%): ¹H NMR (600 MHz, CDCl₃) δ 7.46 (dd, J=7.3, 1.9 Hz, 2H), 7.34 (q, J=5.6 Hz, 3H), 7.21 (d, J=8.3 Hz, 2H), 7.02 (d, J=8.3 Hz, 2H), 2.71 (ddd, J=14.3, 10.0, 4.9 Hz, 1H), 2.43 (ddd, J=13.7, 9.7, 7.0 Hz, 1H), 1.76 (dddd, J=13.5, 10.2, 7.0, 3.5 Hz, 1H), 1.42-1.34 (m, 1H), 1.01 (d, J=7.3 Hz, 3H), 0.87 (dqd, J=10.9, 7.3, 3.5 Hz, 1H), 0.25 (s, 3H), 0.24 (s, 3H); ¹³C NMR (151 MHz, CDCl₃) δ 141.4, 138.5, 134.1, 131.4, 129.9, 129.0, 128.5, 127.8, 34.3, 33.8, 18.9, 14.1, −4.6, −4.9; ²⁹Si NMR (119 MHz, CDCl₃) δ-0.05; FTIR (cm⁻¹):3068, 2953, 2864, 1492, 1427, 1248, 1111, 1092, 1015, 831, 812, 701, 522, 472. HRMS (CI) m/z, calculated for [C₁₈H₂₂SiCl]⁺: 301.1179; found: 301.1166.

According to general procedure B, (DrewPhos)₂PdI₂ (16 mg, 10 μmol), diethyl ether (0.52 mL), dimethylphenylsilyl chloride (200 μL, 1.2 mmol), and [0.79 M] 4-(4-(chloro)phenyl)butan-2-yl)magnesium bromide (1.28 mL, 1.0 mmol) were combined under N₂ and stirred at RT for 24 h. After workup, crude product was purified via silica gel flash chromatography (hexanes) then by reverse phase chromatography on C₁₈ modified silica (gradient from acetonitrile:water=50:50 to acetonitrile:water 100:0) to afford compound (15) as a clear oil (272 mg, 89%): ¹H NMR (600 MHz, CDCl₃) δ 7.52-7.43 (m, 2H), 7.40-7.32 (m, 3H), 7.22 (d, J=8.4 Hz, 2H), 7.03 (d, J=8.3 Hz, 2H), 2.76-2.69 (m, 1H), 2.44 (ddd, J=13.7, 9.7, 7.0 Hz, 1H), 1.77 (dddd, J=13.5, 10.2, 7.0, 3.5 Hz, 1H), 1.40 (dtd, J=13.9, 10.1, 4.9 Hz, 1H), 1.02 (d, J=7.3 Hz, 3H), 0.94-0.83 (m, 1H), 0.27 (s, 3H), 0.26 (s, 3H). ¹³C NMR (151 MHz, CDCl₃) δ 141.4, 138.6, 134.1, 131.5, 129.9, 129.0, 128.5, 127.8, 34.3, 33.8, 18.9, 14.1, −4.6, −4.9. ²⁹Si NMR (119 MHz, CDCl₃) δ-0.05.

### Example 16—Synthesis of Compound (16)

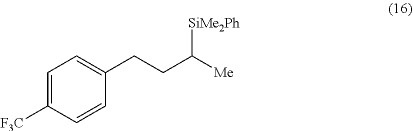

According to general procedure A, (DrewPhos)₂PdI₂ (16 mg, 10 μmol), dioxane (640 μL), triethylamine (140 μL, 1 mmol), dimethylphenylsilyl iodide (360 μL, 2 mmol), and [1.14 M] (4-(4-(trifluoromethyl)phenyl)butan-2yl)zinc bromide (880 μL, 1 mmol) were combined under N₂ and stirred at RT for 8 h. The reaction was quenched with THF (405 μL, 5 equiv, 5 mmol) via syringe and allowed to stir 15 minutes at RT then worked up according to general procedure B and purified via silica gel flash chromatography (hexanes:ethyl acetate=99:1) and product dried (45° C./0.1 mmHg) for 7 h to afford compound (16) as a clear oil (276.1 mg, 81%): ¹H NMR (400 MHz, CDCl₃) δ 7.50 (d, J=8.0 Hz, 2H), 7.48-7.44 (m, 2H), 7.39-7.31 (m, 3H), 7.19 (d, J=8.0 Hz, 2H), 2.80 (ddd, J=14.4, 10.1, 5.0 Hz, 1H), 2.51 (ddd, J=13.6, 9.8, 6.9 Hz, 1H), 1.79 (dddd, J=13.6, 10.2, 6.9, 3.5 Hz, 1H), 1.47-1.36 (m, 1H), 1.02 (d, J=7.2 Hz, 3H), 0.89 (ddp, J=11.4, 7.6, 3.8 Hz, 1H), 0.26 (s, 3H), 0.25 (s, 3H); ¹³C NMR (101 MHz, CDCl₃) δ 147.0, 138.4, 134.0, 129.0, 128.8, 128.0 (q, J=32.2 Hz), 127.8, 125.3 (q, J=3.8 Hz), 124.5 (q, J=271.9 Hz), 34f.8, 33.6, 18.9, 14.1, −4.6, −5.0; ¹⁹F NMR (376 MHz, CDCl₃) 5-62.22; ²⁹Si NMR (119 MHz, CDCl₃) 5-0.03; FTIR (cm⁻¹): 2954, 2866, 2361, 1618, 1427, 1326, 1249, 1163, 1124, 1068, 1018, 814, 701. HRMS (CI) m/z, calculated for [C₁₅H₂₀F₃Si]⁺: 321.1286; found: 321.1271.

### Example 17—Synthesis of Compound (17)

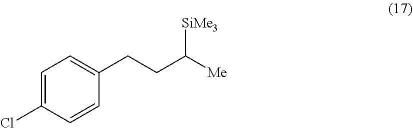 [SMILES: CC(CCc1ccc(Cl)cc1)[Si](C)(C)C]

According to general procedure A, (DrewPhos)₂PdI₂ (16 mg, 10 μmol), dioxane (780 μL), triethylamine (140 μL, 1 mmol), trimethylsilyl iodide (290 μL, 2 mmol), and [1.25 M] (4-(4-chlorophenyl)butan-2-yl)zinc bromide (800 μL, 1 mmol) were combined under N₂ and stirred at RT for 4 h. The reaction was quenched with wet Et₂O (3 mL) and H₂O (3 mL) via syringe then worked up according to general procedure B and purified via silica gel flash chromatography (hexanes) to afford compound (17) as a clear oil (232 mg, 96%): ¹H NMR (600 MHz, CDCl₃) δ 7.25-7.22 (m, 2H), 7.13-7.08 (m, 2H), 2.76 (ddd, J=14.4, 10.1, 4.8 Hz, 1H), 2.47 (ddd, J=13.8, 10.1, 6.7 Hz, 1H), 1.74 (dddd, J=13.8, 10.4, 6.7, 3.6 Hz, 1H), 1.38 (dtd, J=13.5, 10.2, 4.8 Hz, 1H), 0.99 (d, J=7.3 Hz, 3H), 0.65-0.56 (m, 1H), −0.04 (d, J=1.7 Hz, 9H); ¹³C NMR (151 MHz, CDCl₃) δ 141.6, 131.4, 129.9, 128.5, 34.5, 34.0, 19.4, 14.0, −3.1; ²⁹Si NMR (119 MHz, CDCl₃) δ 4.55; FTIR (cm⁺¹): 2953, 2865, 1492, 1248, 1093, 1016, 856, 834, 747, 521. HRMS (CI) m/z, calculated for [C₁₃H₂₀SiCl]⁺: 239.1023; found: 239.1026.

### Example 18—Synthesis of Compound (18)

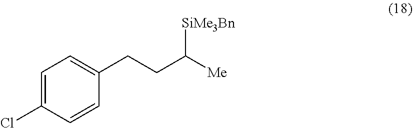

According to general procedure A, (DrewPhos)₂PdI₂ 16 mg, 10 μmol), dioxane (650 μL), triethylamine (140 μL, 1 mmol), benzyldimethylsilyl iodide (410 μL, 2 mmol), and [1.25 M] (4-(4-chlorophenyl)butan-2-yl)zinc bromide (800 μL, 1 mmol) were combined under N₂ and stirred at RT for 4 h. The reaction was diluted with dry THF (405 μL, 5 equiv, 5 mmol) via syringe and allowed to stir 15 minutes at RT then worked up according to general procedure B and purified via silica gel flash chromatography (hexanes) to afford compound (18) as a clear oil (313 mg, 99%): ¹H NMR (600 MHz, CDCl₃) δ 7.24 (d, J=8.3 Hz, 2H), 7.19 (t, J=7.6 Hz, 2H), 7.09 (d, J=8.3 Hz, 2H), 7.06 (t, J=7.6 Hz, 1H), 6.95 (d, J=7.5 Hz, 2H), 2.77 (ddd, J=14.3, 10.1, 4.8 Hz, 1H), 2.45 (ddd, J=13.6, 9.8, 7.0 Hz, 1H), 2.08 (s, 2H), 1.74 (dddd, J=13.4, 10.0, 6.9, 3.2 Hz, 1H), 1.43-1.35 (m, 1H), 1.01 (d, J=7.4 Hz, 3H), 0.69 (dqd, J=10.7, 7.3, 3.2 Hz, 1H), −0.08 (s, 6H); ¹³C NMR (151 MHz, CDCl₃) δ 141.2, 140.2, 131.3, 129.7, 128.4, 128.1, 123.9, 34.1, 33.7, 23.9, 17.8, 13.7, −5.2, −5.3; ²⁹Si NMR (119 MHz, CDCl₃) δ 5.24; FTIR (cm⁻¹): 3081, 3024, 2952, 2864, 1600, 1492, 1452, 1248, 1093, 1015, 830, 699. HRMS (CI) m/z, calculated for [C₁₉H₂₆SiCl]⁺: 317.1492; found: 317.1490.

### Example 19—Synthesis of Compound (19)

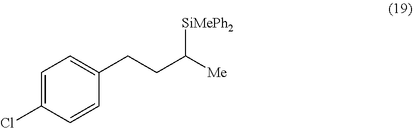

According to general procedure A, (DrewPhos)₂PdI₂ 16 mg, 10 μmol), dioxane (610 μL), triethylamine (140 μL, 1 mmol), methyldiphenylsilyl iodide (450 μL, 2 mmol), and [1.25 M] (4-(4-chlorophenyl)butan-2-yl)zinc bromide (800 μL, 1 mmol) were combined under N₂ and stirred at RT for 4 h. The reaction was quenched with dry THF (405 μL, 5 equiv, 5 mmol) via syringe and allowed to stir 15 minutes at RT then worked up according to general procedure B and purified via silica gel flash chromatography (hexanes) to afford compound (19) as a clear oil (291 mg, 80%): ¹H NMR (600 MHz, CDCl₃) δ 7.49-7.45 (m, 4H), 7.41-7.30 (m, 6H), 7.22 (d, J=8.3 Hz, 2H), 7.01 (d, J=8.2 Hz, 2H), 2.75 (ddd, J=13.9, 9.4, 4.8 Hz, 1H), 2.47 (dt, J=13.7, 8.4 Hz, 1H), 1.91-1.79 (m, 1H), 1.49-1.40 (m, 1H), 1.35-1.23 (m, 1H), 1.08 (d, J=7.3 Hz, 3H), 0.52 (s, 3H); ¹³C NMR (151 MHz, CDCl₃) δ 141.0, 136.4, 136.2, 134.8, 134.8, 131.3, 129.8, 129.1, 129.1, 128.3, 127.8, 127.8, 34.0, 33.6, 17.0, 14.1, −6.4; ²⁹Si NMR (119 MHz, CDCl₃) δ −4.70; FTIR (cm⁻¹): 3068, 2952, 2864, 1491, 1427, 1252, 1111, 1015, 788, 737, 700, 490, 477. HRMS (CI) m/z, calculated for [C₂₃H₂₄SiCl]⁺: 363.1336; found: 363.1320.

### Example 20—Synthesis of Compound (20)

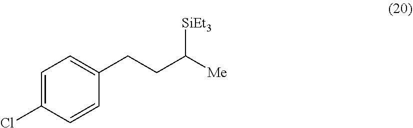

According to general procedure A, (DrewPhos)₂PdI₂ (16 mg, 10 μmol), dioxane (700 μL), triethylamine (140 μL, 1 mmol), triethylsilyl iodide (360 μL, 2 mmol), and [1.25 M] (4-(4-chlorophenyl)butan-2-yl)zinc bromide (800 μL, 1 mmol) were combined under N₂ and stirred at RT for 4 h. The reaction was quenched with wet Et₂O (3 mL) and H₂O (3 mL) via syringe then worked up according to general procedure B and purified via silica gel flash chromatography (hexanes) to afford compound (20) as a clear oil (85 mg, 30%): ¹H NMR (600 MHz, CDCl₃) δ 7.24 (d, J=8.3 Hz, 2H), 7.10 (d, J=8.3 Hz, 2H), 2.79 (ddd, J=14.3, 10.2, 4.8 Hz, 1H), 2.45 (ddd, J=13.6, 9.9, 6.9 Hz, 1H), 1.75 (dddd, J=13.4, 10.0, 6.9, 3.1 Hz, 1H), 1.46-1.38 (m, 1H), 1.02 (d, J=7.4 Hz, 3H), 0.92 (t, J=7.9 Hz, 9H), 0.82-0.74 (m, 1H), 0.53 (q, J=7.9 Hz, 6H); ¹³C NMR (151 MHz, CDCl₃) δ 141.6, 131.4, 129.9, 128.5, 34.6, 34.2, 16.5, 14.2, 7.8, 2.3; ²⁹Si NMR (119 MHz, CDCl₃) δ 8.20; FTIR (cm⁻¹): 2952, 2909, 874, 1492, 1456, 1239, 1093, 1016, 834, 806, 732, 521. HRMS (CI) m/z, calculated for [C₁₄H₂₂SiCl]⁺: 253.1179; found: 253.1177.

### Example 21—Synthesis of Compound (21)

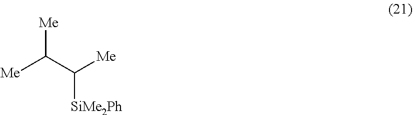

According to general procedure A, (DrewPhos)₂PdI₂ (16 mg, 10 μmol), dioxane (500 μL), triethylamine (140 μL, 1 mmol), dimethylphenylsilyl iodide (360 μL, 2 mmol), and [1.05 M] (3-methylbutan-2-yl)zinc iodide in dioxane (1.00 mL, 1.05 mmol) were combined under N₂ and stirred at RT for 4 h. The reaction was quenched with wet EtOAc (0.5 mL) and brine (3 mL) via syringe then worked up according to general procedure B and purified via silica gel flash chromatography (hexanes) to afford compound (21) as a clear volatile oil (175.1 mg, 81%): ¹H NMR (600 MHz, CDCl₃) δ 7.54-7.51 (m, 2H), 7.37-7.33 (m, 3H), 1.87 (heptd, J=6.8, 3.4 Hz, 1H), 0.94-0.89 (m, 7H), 0.81 (d, J=6.9 Hz, 3H), 0.30 (s, 3H), 0.29 (s, 3H); ¹³C NMR (151 MHz, CDCl₃) δ 139.9, 134.0, 128.7, 127.8, 29.0, 26.8, 23.2, 19.9, 9.7, −3.2, −3.3; ²⁹Si NMR (119 MHz, CDCl₃) δ-0.85; FTIR (cm⁻¹): 2955, 2871, 1465, 1427, 1248, 1111, 834, 817, 768, 733, 700. HRMS (CI) m/z, calculated for [C₁₃H₂₂Si]⁺: 206.1491; found: 206.1482.

### Example 22—Synthesis of Compounds (22) and (23)

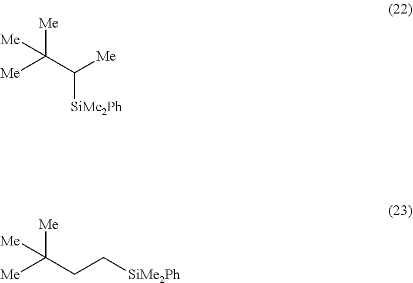

According to general procedure A, (DrewPhos)₂PdI₂ (16 mg, 10 μmol), dioxane (60 μL), triethylamine (140 μL, 1 mmol), dimethylphenylsilyl iodide (360 μL, 2 mmol), and [0.54 M] (3,3-dimethylbutan-2-yl)zinc iodide (1.85 mL, 1 mmol) were combined under N₂ and stirred at RT for 8 h. The reaction was quenched with wet EtOAc (0.5 mL) and brine (3 mL) via syringe then worked up according to general procedure B and purified via silica gel flash chromatography (hexanes) to afford an inseparable mixture of isomers (22):(23) (62:38) as a clear oil (123.0 mg, 56%): Useful diagnostic peaks for each compound are listed. (22): ¹H NMR (400 MHz, CDCl₃) δ 7.56-7.50 (m, 2H), 7.38-7.31 (m, 3H), 0.98-0.92 (m, 4H), 0.89 (s, 9H), 0.36 (s, 3H), 0.32 (s, 3H); ¹³C NMR (101 MHz, CDCl₃) δ 141.2, 134.0, 128.6, 127.7, 33.7, 32.3, 30.3, 11.9, −0.5, −2.0; ²⁹Si NMR (119 MHz, CDCl₃) δ-2.06. HRMS (CI) m/z, calculated for [C₁₃H₂₁Si]⁺: 205.1413; found: 205.1407. (23): ¹H NMR (400 MHz, CDCl₃) δ 7.55-7.50 (m, 2H), 7.38-7.31 (m, 3H), 1.22-1.15 (m, 2H), 0.85 (s, 9H), 0.72-0.65 (m, 2H), 0.25 (s, 6H); ¹³C NMR (101 MHz, CDCl₃) δ 139.8, 133.7, 128.9, 127.8, 37.9, 31.2, 28.9, 9.8, −3.0; ²⁹Si NMR (119 MHz, CDCl₃) δ −2.21. HRMS (CI) m/z, calculated for [C₁₃H₂₁Si]⁺: 205.1413; found: 205.1406. (22)+(23): FTIR (cm⁻¹): 2955, 2911, 1466, 1427, 1363, 1249, 1112, 834, 815, 700.

### Example 23—Synthesis of Compound (24)

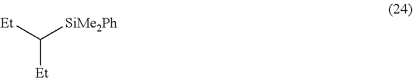

According to general procedure B, (DrewPhos)₂PdI₂ (16 mg, 10 μmol), Et₂O (0.3 mL), dimethylphenylsilyl chloride (200 μL, 1.2 mmol), and [0.67 M] 3-pentylmagnesium bromide (1.50 mL, 1.0 mmol) were combined under N₂ and stirred at RT for 24 h. After workup, the crude product was purified via silica gel flash chromatography (hexanes) to afford compound (24) as a clear oil (203 mg, 99%): ¹H NMR (600 MHz, CDCl₃) δ 7.55-7.50 (m, 2H), 7.38-7.34 (m, 3H), 1.54 (dqd, J=14.7, 7.5, 5.3 Hz, 2H), 1.38 (dp, J=14.7, 7.4 Hz, 2H), 0.88 (t, J=7.4 Hz, 6H), 0.72 (tt, J=7.5, 5.1 Hz, 1H), 0.29 (s, 6H). ¹³C NMR (151 MHz, CDCl₃) δ 139.8, 134.0, 128.8, 127.8, 29.04, 21.9, 13.8, −3.4. ²⁹Si NMR (119 MHz, CDCl₃) δ 1.0.

### Example 24—Synthesis of Compound (25)

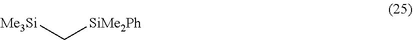

According to general procedure B, (DrewPhos)₂PdI₂ (16 mg, 10 μmol), diethyl ether (0.76 mL), dimethylphenylsilyl chloride (200 μL, 1.2 mmol), and [0.96 M](trimethylsilyl)methylmagnesium chloride (1.04 mL, 1.0 mmol) were combined under N₂ and stirred at RT for 24 h. After workup, crude product was purified via silica gel flash chromatography (hexanes) to afford compound (25) as a clear oil (122 mg, 55%): ¹H NMR (600 MHz, CDCl₃) δ 7.59-7.48 (m, 2H), 7.38-7.33 (m, 3H), 0.31 (s, 6H), 0.02 (s, 2H), −0.01 (s, 9H). ¹³C NMR (151 MHz CDCl₃) δ 141.5, 133.4, 128.86, 127.8, 3.4, 1.4, 0.0. ²⁹Si NMR (119 MHz, CDCl₃) δ 0.5, −4.2. FTIR (cm⁻¹): 2953, 2897, 1426, 1250, 1113, 1051, 836, 698. HRMS (CI) m/z, calculated for [C₁NH₁₉Si₂]⁺[M−CH₃]⁺: 207.1025; found: 207.1027.

### Example 25—Synthesis of Compound (26)

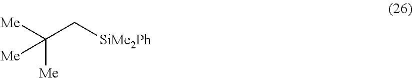

According to general procedure B, (DrewPhos)₂PdI₂ (16 mg, 10 μmol), Et₂O (750 μL), dimethylphenylsilyl chloride (200 μL, 1.2 mmol), and [0.95 M] neopentylmagnesium bromide (1.05 mL, 1.0 mmol) were combined under N₂ and stirred at RT for 24 h. After workup, crude product was purified via silica gel flash chromatography (hexanes) to afford compound (26) as a clear oil (205 mg, 99%): 1H NMR (400 MHz, CDCl₃) δ 7.55-7.52 (m, 2H), 7.42-7.29 (m, 3H), 0.95 (s, 11H), 0.35 (s, 6H). ¹³C NMR (101 MHz, CDCl₃) δ 141.0, 133.6, 128.7, 127.8, 33.2, 33.2, 31.3, −0.4. ²⁹Si NMR (119 MHz, CDCl₃) δ −5.7. FTIR (cm⁻¹): 2954, 2893, 2869, 1465, 1427, 1363, 1249, 1113, 832, 707. HRMS (CI) m/z, calculated for [C₁₃H₂₂Si]⁺[M]⁺: 206.1491; found: 206.1501.

### Example 26—Synthesis of Compound (27)

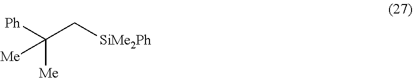

According to general procedure B, (DrewPhos)₂PdI₂(16 mg, 10 μmol), Et₂O (50 μL), dimethylphenylsilyl chloride (200 μL, 1.2 mmol), and [0.40 M] 2-methyl-2-phenylpropylmagnesium chloride (2.50 mL, 1.0 mmol) were combined under N₂ and stirred at RT for 24 h. After workup, crude product was purified via silica gel flash chromatography (hexanes) to afford compound (27) as a clear oil (136.2 mg, 51%): ¹H NMR (600 MHz, CDCl₃) δ 7.42-7.37 (m, 2H), 7.33-7.32 (m, 2H), 7.30-7.27 (m, 3H), 7.27-7.22 (m, 2H), 7.15-7.13 (m, 1H), 1.37 (s, 2H), 1.32 (s, 6H), 0.01 (s, 6H). ¹³C NMR (151 MHz, CDCl₃) δ 151.1, 140.8, 133.6, 128.7, 128.1, 127.8, 125.7, 125.6, 37.5, 34.2, 32.6, −1.2. ²⁹Si NMR (119 MHz, CDCl₃) δ −5.7. FTIR (cm⁻¹): 2959, 2360, 2339, 1652, 1558, 1456, 1110, 826. 668. HRMS (CI) m/z, calculated for C₁₇H₂₁Si⁺[M−CH₃]⁺: 253.1413; found: 253.1417.

### Example 27—Synthesis of Compound (28)

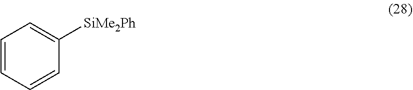

According to general procedure B, (DrewPhos)₂PdI₂ (16 mg, 10 μmol), Et₂O (1.40 mL), dimethylphenylsilyl chloride (200 μL, 1.2 mmol), and [2.62 M]phenylmagnesium bromide (400 μL, 1.0 mmol) were combined under N₂ and stirred at RT for 24 h. After workup, crude product was purified via silica gel flash chromatography (hexanes) then by reverse phase chromatography on C₁₈ modified silica (gradient from acetonitrile:water=50:50 to acetonitrile:water=100:0) to afford compound (28) as a clear oil (215 mg, 97%): ¹H NMR (600 MHz, CDCl₃) δ 7.61-7.50 (m, 4H), 7.40-7.35 (m, 6H), 0.59 (s, 6H). ¹³C NMR (151 MHz, CDCl₃) δ 138.4, 134.4, 129.2, 128.0, −2.2. ²⁹Si NMR (119 MHz, CDCl₃) δ −8.1.

### Example 28—Synthesis of Compound (29)

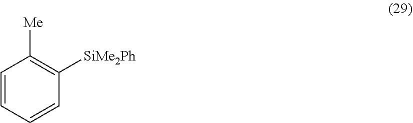

According to general procedure B, (DrewPhos)₂PdI₂ (16 mg, 10 μmol), Et₂O (1.3 mL), dimethylphenylsilyl chloride (200 μL, 1.2 mmol), and [2.0 M] ortho-tolylmagnesium bromide (0.500 mL, 1.0 mmol) were combined under N₂ and stirred at RT for 24 h. After workup, crude product was purified via silica gel flash chromatography (hexanes) to afford compound (29) as a clear oil (210 mg, 93%): ¹H NMR (600 MHz, CD₂Cl₂) δ 7.51-7.47 (m, 3H), 7.38-7.31 (m, 3H), 7.29 (td, J=7.5, 1.3 Hz, 1H), 7.18 (t, J=7.4 Hz, 1H), 7.14 (d, J=7.6 Hz, 1H), 2.25 (s, 3H), 0.58 (s, 6H), ¹³C NMR (151 MHz, CD₂Cl₂) δ 144.7, 139.7, 136.8, 135.9, 134.6, 130.4, 130.1, 129.5, 128.4, 125.5, 23.5, −1.0, ²⁹Si NMR (119 MHz, CDCl₃) δ-8.1, FTIR (cm⁻¹): 3067, 3050, 3003, 2956, 1589, 1428, 1250, 1130, 1112, 817, 775, 701, 642, 474. HRMS (CI) m/z, calculated for C₁₄H₁₅Si⁺[M]⁺: 211.0943; found: 211.0952.

### Example 29—Synthesis of Compound (30)

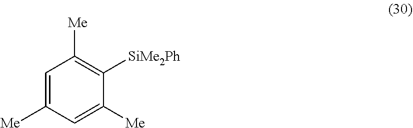

According to general procedure B, (DrewPhos)₂PdI₂ (16 mg, 10 μmol), Et₂O (720 μL), dimethylphenylsilyl chloride (200 μL, 1.2 mmol), and [0.93 M] 2-mesitylmagnesium bromide (1.08 mL, 1.0 mmol) were combined under N₂ and stirred at RT for 24 h. After workup, crude product was purified via silica gel flash chromatography (hexanes) to afford compound (30) as a clear oil (250 mg, 98%): 1H NMR (400 MHz, CDCl₃) δ 7.52-7.44 (m, 2H), 7.35-7.29 (m, 3H), 6.84 (s, 2H), 2.30 (s, 6H), 2.29 (s, 3H), 0.63 (s, 6H). ¹³C NMR (101 MHz, CDCl₃) δ 145.2, 141.7, 139.2, 133.5, 130.8, 129.3, 128.7, 128.0, 25.1, 21.1, 3.2. ²⁹Si NMR (119 MHz, CDCl₃) δ −9.0. FTIR (cm⁻¹): 2954, 1605, 1450, 1427, 1250, 1105, 816, 701, 667. HRMS (CI) m/z, calculated for C₁₇H₂₂Si [M]⁺: 254.1491; found: 254.1495.

### Example 30—Synthesis of Compound (31)

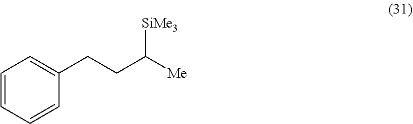 [SMILES: CC(CCc1ccccc1)[Si](C)(C)C]

According to procedure B, (DrewPhos)₂PdI₂(16 mg, 10 μmol), Et₂O (1.04 mL), trimethylsilyl chloride (150 μL, 1.2 mmol), and [1.43 M] (4-phenylbutan-2-yl)magnesium bromide (700 μL, 1.0 mmol) were combined under N₂ and stirred at RT for 24 h. After workup, crude product was purified via silica gel flash chromatography (hexanes) to afford compound (31) as a clear oil (154 mg, 75%): ¹H NMR (600 MHz, CDCl₃) δ 7.29 (t, J=7.6 Hz, 2H), 7.21-7.16 (m, 3H), 2.81 (ddd, J=14.8, 10.6, 4.9 Hz, 1H), 2.51 (ddd, J=13.5, 10.3, 6.6 Hz, 1H), 1.79 (dddd, J=13.9, 10.3, 6.5, 3.7 Hz, 1H), 1.49-1.33 (m, 1H), 1.01 (d, J=7.4 Hz, 3H), 0.65 (dqd, J=10.9, 7.4, 3.7 Hz, 1H), −0.03 (s, 9H), ¹³C NMR (151 MHz, CDCl₃) δ 143.3, 128.6, 128.4, 125.7, 35.2, 34.1, 19.6, 14.0, −3.1, ²⁹Si NMR (119 MHz, CDCl₃) δ 4.53, FTIR (cm⁻¹): 3027, 2953, 2865, 1604, 1496, 1454, 1248, 856, 834, 745, 698. HRMS (CI) m/z, calculated for [C₁₃H₂₁Si]⁺: 205.1413; found: 205.1418.

### Example 31—Synthesis of Compound (32)

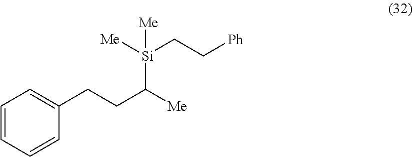 [SMILES: CC(CCc1ccccc1)[Si](C)(C)CCc1ccccc1]

According to procedure B, (DrewPhos)₂PdI₂ (16 mg, 10 μmol), Et₂O (950 μL), phenethyldimethylsilyl chloride (240 μL, 1.2 mmol), and [1.23 M] (4-phenylbutan-2-yl)magnesium bromide (810 μL, 1.0 mmol) were combined under N₂ and stirred at RT for 24 h. After workup, crude product was purified via silica gel flash chromatography (hexanes) then by reverse phase chromatography on C₁₈ modified silica (gradient from acetonitrile:water=75:25 to acetonitrile:water=95:0) to afford compound (32) as a clear oil (280 mg, 94%): ¹H NMR (600 MHz, CD₂Cl₂) δ 7.29-7.23 (m, 4H), 7.22-7.12 (m, 6H), 2.82 (ddd, J=14.3, 10.5, 4.8 Hz, 1H), 2.59 (dd, J=11.4, 6.1 Hz, 2H), 2.50 (ddd, J=13.6, 10.1, 6.7 Hz, 1H), 1.84-1.76 (m, 1H), 1.47-1.39 (m, 1H), 1.04 (d, J=7.4 Hz, 3H), 0.90-0.85 (m, 2H), 0.78-0.70 (m, 1H), −0.01 (s, 6H), ¹³C NMR (151 MHz, CDCl₃) δ 145.5, 143.1, 128.6, 128.4, 127.9, 125.8, 125.7, 35.2, 34.1, 30.2, 18.5, 16.1, 14.0, −4.98, −5.00, ²⁹Si NMR (119 MHz, CDCl₃) δ 5.5. HRMS (CI) m/z, calculated for [C₁₉H₂₅Si]⁺: 281.1726; found: 281.1716.

### Example 32—Synthesis of Compound (33)

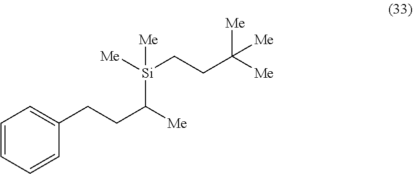 [SMILES: CC(CCc1ccccc1)[Si](C)(C)CCC(C)(C)C]

According to procedure B, (DrewPhos)₂PdI₂ (16 mg, 10 μmol), Et₂O (930 μL), (3,3-dimethylbutyl)dimethylsilyl chloride (250 μL, 1.2 mmol), and [1.23 M] (4-phenylbutan-2-yl)magnesium bromide (810 μL, 1.0 mmol) were combined under N₂ and stirred at RT for 24 h. After workup, crude product was purified via silica gel flash chromatography (hexanes) then by reverse phase chromatography on C₁₈ modified silica (gradient from acetonitrile:water=75:25 to acetonitrile:water=100:0) to afford compound (33) as a clear oil (255 mg, 92%): ¹H NMR (600 MHz, CDCl₃) δ 7.28 (t, J=7.6 Hz, 2H), 7.21-7.16 (m, 3H), 2.82 (ddd, J=14.1, 10.4, 4.8 Hz, 1H), 2.50 (ddd, J=13.5, 10.1, 6.7 Hz, 1H), 1.78 (dddd, J=13.7, 10.3, 6.7, 3.5 Hz, 1H), 1.46-1.37 (m, 1H), 1.11 (ddd, J=12.7, 5.8, 2.1 Hz, 2H), 1.01 (d, J=7.4 Hz, 3H), 0.84 (s, 9H), 0.74-0.66 (m, 1H), 0.45-0.40 (m, 2H), −0.07 (s, 3H), −0.07 (s, 3H), ¹³C NMR (151 MHz, CDCl₃) δ 143.2, 128.6, 128.4, 125.7, 38.0, 35.2, 34.1, 31.2, 29.0, 18.4, 14.1, 7.8, −5.1, ²⁹Si NMR (119 MHz, CDCl₃) δ 6.14, FTIR (cm⁻¹): 3027, 2952, 2913, 2865, 1604, 1466, 1454, 1363, 1248, 1159, 886, 835, 745, 698. HRMS (CI) m/z, calculated for [C₁₇H₂₉Si]⁺: 261.2039; found: 261.2038.

### Example 33—Synthesis of Compound (34)

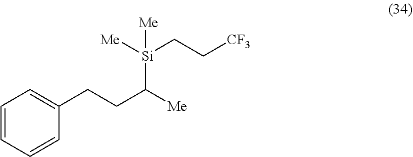 [SMILES: CC(CCc1ccccc1)[Si](C)(C)CCC(F)(F)F]

According to procedure B, (DrewPhos)₂PdI₂ (16 mg, 10 μmol), Et₂O (1.23 mL), (3,3,3-trifluoropropyl)dimethylsilyl chloride (210 μL, 1.2 mmol), and [1.78 M] (4-phenylbutan-2-yl)magnesium bromide (560 μL, 1.0 mmol) were combined under N₂ and stirred at RT for 24 h. After workup, crude product was purified via silica gel flash chromatography (hexanes) to afford compound (34) as a clear oil (234 mg, 81%): ¹H NMR (600 MHz, CDCl₃) δ 7.29 (t, J=7.6 Hz, 2H), 7.21-7.15 (m, 3H), 2.83 (ddd, J=14.2, 10.1, 4.8 Hz, 1H), 2.51 (ddd, J=13.6, 9.8, 6.9 Hz, 1H), 2.03-1.89 (m, 2H), 1.77 (dddd, J=13.6, 10.2, 6.9, 3.3 Hz, 1H), 1.49-1.39 (m, 1H), 1.03 (d, J=7.4 Hz, 3H), 0.78-0.66 (m, 3H), −0.01 (s, 3H), −0.01 (s, 3H), ¹³C NMR (151 MHz, CDCl₃) δ 142.7, 128.5, 128.5, 127.80 (q, J=276.7 Hz) 125.9, 34.9, 33.8, 28.95 (q, J=29.8 Hz), 18.0, 13.8, 5.5, −5.3, −5.4, ¹⁹F NMR (565 MHz, C CDCl₃) δ 68.78, ²⁹Si NMR (119 MHz, CDCl₃) δ 6.11, FTIR (cm⁻¹): 3028, 2953, 2867, 1604, 1497, 1364, 1264, 1212, 1125, 1067, 900, 844, 699. HRMS (CI) m/z, calculated for [C₁₅H₂₄F₃Si]⁺: 289.1599; found: 289.1587.

### Example 34—Synthesis of Compound (35)

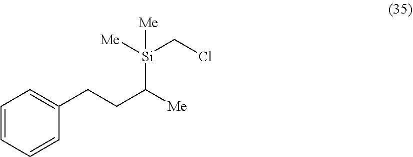 [SMILES: CC(CCc1ccccc1)[Si](C)(C)CCl]

According to procedure B, (DrewPhos)₂PdI₂ (16 mg, 10 μmol), Et₂O (1.1 mL), chloromethyldimethylsilyl chloride (160 μL, 1.2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) to afford compound (35) as a clear oil (154 mg, 64%): ¹H NMR (600 MHz, CDCl₃) δ 7.29 (t, J=7.7 Hz, 2H), 7.21-7.16 (m, 3H), 2.81 (s, 3H), 2.52 (ddd, J=13.5, 10.3, 6.5 Hz, 1H), 1.80 (dddd, J=13.9, 10.3, 6.5, 3.6 Hz, 1H), 1.51-1.42 (m, 1H), 1.05 (d, J=7.4 Hz, 3H), 0.90 (dqd, J=11.1, 7.3, 3.6 Hz, 1H), 0.10 (s, 3H), 0.09 (s, 3H), ¹³C NMR (151 MHz, CDCl₃) δ 142.7, 128.5, 128.5, 125.9, 35.0, 33.8, 29.5, 17.6, 13.9, −6.0, −6.1, ²⁹Si NMR (119 MHz, CDCl₃) δ 6.21, FTIR (cm⁻¹): 3027, 2954, 2927, 2865, 1604, 1496, 1454, 1251, 842, 746, 699. HRMS (CI) m/z, calculated for [C₁₃H₂₂ClSi]⁺: 241.1179; found: 241.1182.

### Example 35—Synthesis of Compound (36)

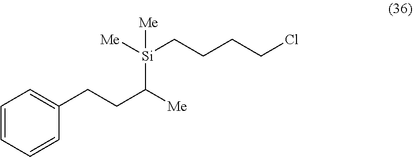 [SMILES: CC(CCc1ccccc1)[Si](C)(C)CCCCCl]

According to procedure B, (DrewPhos)₂PdI₂ (16 mg, 10 μmol), Et₂O (970 μL), 4-chlorobutyldimethylsilyl chloride (220 μL, 1.2 mmol), and [1.23 M] (4-phenylbutan-2-yl)magnesium bromide (810 μL, 1.0 mmol) were combined under N₂ and stirred at RT for 24 h. After workup, crude product was purified via silica gel flash chromatography (hexanes) to afford compound (36) as a clear oil (247 mg, 87%): ¹H NMR (600 MHz, CDCl₃) δ 7.28 (dd, J=8.3, 6.9 Hz, 2H), 7.21-7.14 (m, 3H), 3.53 (t, J=6.6 Hz, 2H), 2.81 (ddd, J=13.6, 10.3, 4.8 Hz, 1H), 2.50 (ddd, J=13.5, 10.1, 6.7 Hz, 1H), 1.82-1.73 (m, 3H), 1.46-1.36 (m, 3H), 1.01 (d, J=7.4 Hz, 3H), 0.69 (dqd, J=10.8, 7.3, 3.5 Hz, 1H), 0.55-0.48 (m, 2H), −0.05 (s, 3H), −0.05 (s, 3H), ¹³C NMR (151 MHz, CDCl₃) δ 143.1, 128.6, 128.4, 125.7, 44.9, 36.4, 35.1, 34.1, 21.4, 18.5, 14.0, 13.1, −4.98, −5.01, ²⁹Si NMR (119 MHz, CDCl₃) δ 5.45, FTIR (cm⁻¹): 3026, 2952, 2931, 2864, 1603, 1496, 1454, 1248, 834, 747, 699. HRMS (CI) m/z, calculated for [C₁₆H₂₈ClSi]⁺: 283.1649; found: 283.1658.

### Example 36—Synthesis of Compound (37)

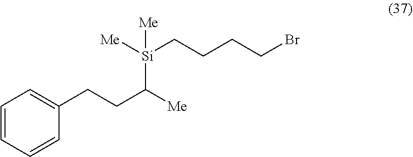 [SMILES: CC(CCc1ccccc1)[Si](C)(C)CCCCBr]

According to procedure B, (DrewPhos)₂PdI₂ (16 mg, 10 μmol), Et₂O (810 μL), 4-bromobutyldimethylsilyl chloride (220 μL, 1.2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) then reverse phase chromatography on C₁₈ modified silica (gradient from acetonitle:water=70:30 to acetonitrile:water=100:0) to afford compound (37) as a clear oil (302 mg, 92%): ¹H NMR (600 MHz, CDCl₃) δ 7.28 (t, J=7.6 Hz, 2H), 7.18 (d, J=6.4 Hz, 3H), 3.41 (t, J=6.8 Hz, 2H), 2.82 (ddd, J=14.7, 10.4, 4.8 Hz, 1H), 2.49 (ddd, J=13.5, 10.1, 6.7 Hz, 1H), 1.85 (p, J=6.9 Hz, 2H), 1.77 (dddd, J=13.7, 10.2, 6.7, 3.4 Hz, 1H), 1.41 (dddd, J=14.7, 10.3, 6.8, 3.5 Hz, 3H), 1.01 (d, J=7.3 Hz, 3H), 0.69 (dqd, J=10.8, 7.4, 3.4 Hz, 1H), 0.53-0.47 (m, 2H), −0.05 (s, 6H), ¹³C NMR (151 MHz, CDCl₃) δ 143.1, 128.6, 128.4, 125.7, 36.6, 35.1, 34.1, 33.8, 22.6, 18.4, 14.0, 12.9, −4.98, −5.01, ²⁹Si NMR (119 MHz, CDCl₃) δ 5.42, FTIR (cm⁻¹): 3026, 2951, 2930, 2864, 1603, 1496, 1454, 1248, 835, 748, 699. HRMS (CI) m/z, calculated for [C₁₅H₂₄BrSi]⁺: 311.0831; found: 311.0842.

### Example 37—Synthesis of Compound (38)

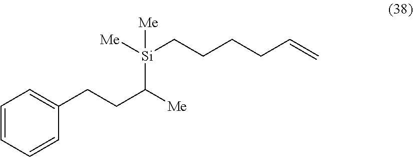 [SMILES: C=CCCCC[Si](C)(C)C(C)CCc1ccccc1]

According to procedure B, (DrewPhos)₂PdI₂ (16 mg, 10 μmol), Et₂O (950 μL), 5-hexenyldimethylsilyl chloride (240 μL, 1.2 mmol), and [1.23 M] (4-phenylbutan-2-yl)magnesium bromide (810 μL, 1.0 mmol) were combined under N₂ and stirred at RT for 24 h. After workup, crude product was purified via silica gel flash chromatography (hexanes) then reverse phase chromatography on C₁₈ modified silica (gradient from acetonitle:water=70:30 to acetonitrile:water=100:0) to afford compound (38) as a clear oil (251 mg, 91%): ¹H NMR (600 MHz, CDCl₃) δ 7.31-7.26 (m, 2H), 7.20-7.15 (m, 3H), 5.80 (ddt, J=16.9, 10.2, 6.7 Hz, 1H), 4.99 (dq, J=17.1, 1.5 Hz, 1H), 4.95-4.91 (m, 1H), 2.84-2.77 (m, 1H), 2.49 (ddd, J=13.5, 10.2, 6.6 Hz, 1H), 2.04 (q, J=7.0 Hz, 2H), 1.77 (dddd, J=13.7, 10.2, 6.6, 3.5 Hz, 1H), 1.45-1.35 (m, 3H), 1.31-1.24 (m, 2H), 1.00 (d, J=7.4 Hz, 3H), 0.68 (dqd, J=10.8, 7.4, 3.5 Hz, 1H), 0.53-0.47 (m, 2H), −0.07 (s, 3H), −0.07 (s, 3H), ¹³C NMR (151 MHz, CDCl₃) δ 143.2, 139.3, 128.6, 128.4, 125.7, 114.3, 35.2, 34.1, 33.6, 33.1, 23.6, 18.6, 14.1, 13.7, −4.9, ²⁹Si NMR (119 MHz, CDCl₃) δ 5.31. FTIR (cm⁻¹): 3063, 3027, 2923, 2854, 1641, 1604, 1496, 1454, 1248, 909, 834, 746, 698. HRMS (CI) m/z, calculated for [C₁₇H₂₇Si]⁺: 259.1882; found: 259.1882.

### Example 38—Synthesis of Compound (39)

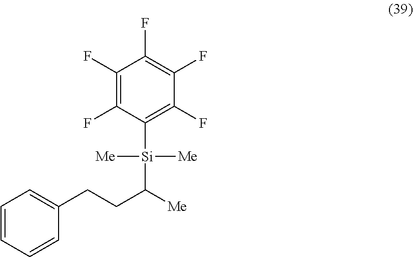 [SMILES: CC(CCc1ccccc1)[Si](C)(C)c1c(F)c(F)c(F)c(F)c1F]

According to procedure B, (DrewPhos)₂PdI₂ (16 mg, 10 μmol), Et₂O (1.0 mL), pentafluorophenyldimethylsilyl chloride (230 μL, 1.2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) to afford compound (39) as a clear oil (227 mg, 63%): ¹H NMR (600 MHz, CD₂Cl₂) δ 7.25 (t, J=7.6 Hz, 2H), 7.15 (t, J=7.4 Hz, 1H), 7.12 (d, J=7.2 Hz, 2H), 2.80 (ddd, J=14.6, 10.3, 4.9 Hz, 1H), 2.49 (ddd, J=13.5, 10.0, 6.7 Hz, 1H), 1.76 (dddd, J=13.7, 10.2, 6.7, 3.4 Hz, 1H), 1.45 (dddd, J=16.9, 12.2, 8.5, 3.5 Hz, 1H), 1.09 (dp, J=12.3, 4.7, 4.1 Hz, 1H), 1.04 (d, J=6.9 Hz, 3H), 0.39 (s, 3H), 0.38 (s, 3H), ¹³C NMR (151 MHz, CDCl₃) δ 149.2 (dddt, J=241.4, 17.4, 8.7, 4.0 Hz), 142.5, 142.0 (dtt, J=254.3, 12.9, 5.7 Hz), 138.3-136.2 (m), 128.5, 125.9, 110.0-109.3 (m), 34.9, 33.6, 19.0, 13.8, −3.34 (dt, J=14.4, 3.7 Hz), ¹⁹F NMR (565 MHz, CD₂Cl₂) δ −126.48-−126.61 (m), −152.97 (t, J=19.8 Hz), −162.37 (td, J=22.6, 8.6 Hz), ²⁹Si NMR (119 MHz, CDCl₃) δ 4.07, FTIR (cm⁻¹): 3028, 2955, 2868, 1642, 1517, 1457, 1374, 1283, 1256, 1086, 969, 841, 802, 747, 699. HRMS (CI) m/z, calculated for [C₁₇H₁₆F₅Si]⁺: 343.0941; found: 343.0945.

### Example 39—Synthesis of Compound (40)

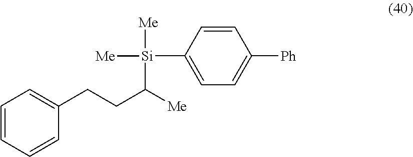 [SMILES: CC(CCc1ccccc1)[Si](C)(C)c1ccc(-c2ccccc2)cc1]

According to procedure B, (DrewPhos)₂PdI₂ (16 mg, 10 μmol), Et₂O (1.3 mL), 4-biphenyldimethylsilyl chloride (300 mg, 1.2 mmol), and [1.43 M] (4-phenylbutan-2-yl)magnesium bromide (700 μL, 1.0 mmol) were combined under N₂ and stirred at RT for 24 h. After workup, crude product was purified via silica gel flash chromatography (hexanes) then reverse phase chromatography on C₁₈ modified silica (gradient from acetonitle:water=80:20 to acetonitrile:water=90:10) to afford compound (40) as a clear oil (287 mg, 83%): ¹H NMR (600 MHz, CD₂Cl₂) δ 7.64-7.61 (m, 2H), 7.61-7.55 (m, 4H), 7.45 (t, J=7.6 Hz, 2H), 7.36 (t, J=7.3 Hz, 1H), 7.25 (t, J=7.5 Hz, 2H), 7.14 (t, J=6.3 Hz, 3H), 2.84-2.76 (m, 1H), 2.53-2.44 (m, 1H), 1.87-1.78 (m, 1H), 1.48-1.39 (m, 1H), 1.06 (t, J=5.9 Hz, 3H), 1.00-0.92 (m, 1H), 0.31-0.27 (m, 6H), ¹³C NMR (151 MHz, CDCl₃) δ 143.0, 141.7, 141.3, 137.4, 134.6, 128.9, 128.6, 128.4, 127.5, 127.3, 126.5, 125.7, 35.0, 33.9, 19.0, 14.2, −4.5, −4.7, ²⁹Si NMR (119 MHz, CDCl₃) δ −0.04, FTIR (cm⁻¹): 3062, 3025, 2952, 2863, 1597, 1496, 1485, 1454, 1384, 1250, 1115, 1007, 826, 811, 756, 697. HRMS (CI) m/z, calculated for [C₂₃H₂₅Si]⁺: 329.1726; found: 329.1731.

### Example 40—Synthesis of Compound (41)

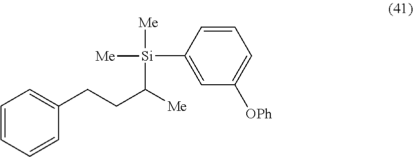 [SMILES: CC(CCc1ccccc1)[Si](C)(C)c1cccc(Oc2ccccc2)c1]

According to procedure B, (DrewPhos)₂PdI₂(16 mg, 10 μmol), Et₂O (1.0 mL), 3-phenoxydimethylsilyl chloride (285 μL, 1.2 mmol), and [1.43 M] (4-phenylbutan-2-yl)magnesium bromide (700 μL, 1.0 mmol) were combined under N₂ and stirred at RT for 24 h. After workup, crude product was purified via silica gel flash chromatography (hexanes) then reverse phase chromatography on C₁₈ modified silica (gradient from acetonitle:water=80:20 to acetonitrile:water=90:10) to afford compound (41) as a clear oil (314 mg, 87%): ¹H NMR (600 MHz, CD₂Cl₂) δ 7.32 (q, J=7.5 Hz, 3H), 7.26-7.22 (m, 3H), 7.18-7.13 (m, 2H), 7.11 (d, J=7.1 Hz, 2H), 7.09 (t, J=7.4 Hz, 1H), 7.00-6.95 (m, 3H), 2.76 (ddd, J=14.9, 10.4, 4.9 Hz, 1H), 2.46 (ddd, J=13.5, 10.2, 6.6 Hz, 1H), 1.78 (dddd, J=13.8, 10.3, 6.6, 3.6 Hz, 1H), 1.40 (dtd, J=13.6, 10.2, 4.9 Hz, 1H), 1.02 (d, J=7.3 Hz, 3H), 0.96-0.87 (m, 1H), 0.25 (s, 3H), 0.24 (s, 3H), ¹³C NMR (151 MHz, CD₂Cl₂) δ 158.2, 157.0, 143.5, 141.7, 130.3, 129.7, 129.6, 128.9, 128.8, 126.1, 125.1, 123.5, 120.0, 118.9, 35.4, 34.4, 19.4, 14.3, −4.5, −4.8, ²⁹Si NMR (119 MHz, CDCl₃) δ 0.34, FTIR (cm⁻¹): 3061, 3026, 2952, 2864, 1566, 1489, 1476, 1401, 1226, 1110, 812, 771, 697. HRMS (CI) m/z, calculated for [C₂₃H₂₅SiO]⁺: 345.1675; found: 345.1685.

### Example 41—Synthesis of Compound (42)

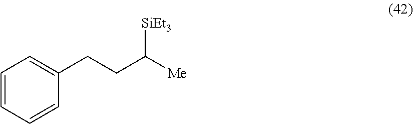

According to procedure C, (DrewPhos)₂PdI₂ (16 mg, 10 μmol), Bu₂O (910 μL), triethylsilyl chloride (340 μL, 2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) to afford compound (42) as a clear oil (249 mg, 99%): ¹H NMR (600 MHz, CDCl₃) δ 7.28 (t, J=7.6 Hz, 2H), 7.20-7.15 (m, 3H), 2.84 (ddd, J=14.1, 10.5, 4.8 Hz, 1H), 2.48 (ddd, J=13.5, 10.2, 6.7 Hz, 1H), 1.80 (dddd, J=13.6, 10.0, 6.6, 3.1 Hz, 1H), 1.50-1.41 (m, 1H), 1.04 (d, J=7.4 Hz, 3H), 0.93 (t, J=8.0 Hz, 9H), 0.81 (dqd, J=10.6, 7.4, 3.3 Hz, 1H), 0.54 (q, J=8.0 Hz, 6H), ¹³C NMR (151 MHz, CDCl₃) δ 143.2, 128.6, 128.4, 125.7, 35.3, 34.3, 16.7, 14.3, 7.8, 2.3, ²⁹Si NMR (119 MHz, CDCl₃) δ 8.21, FTIR (cm⁻¹): 3027, 2952, 2909, 2874, 1604, 1496, 1454, 1416, 1238, 1016, 730, 698. HRMS (CI) m/z, calculated for [C₁₆H₂₇Si]⁺: 247.1882; found: 247.1884.

### Example 42—Synthesis of Compound (43)

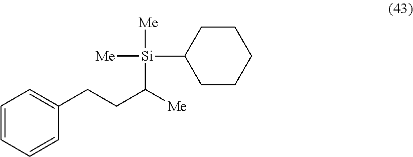 [SMILES: CC(CCc1ccccc1)[Si](C)(C)C1CCCCC1]

According to procedure C, (DrewPhos)₂PdI₂ 16 mg, 10 μmol), Bu₂O (880 μL), cyclohexyldimethylsilyl chloride (370 μL, 2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) to afford compound (43) as a clear oil (210 mg, 90%): ¹H NMR (600 MHz, CDCl₃) δ 7.28 (t, J=7.6 Hz, 2H), 7.20-7.15 (m, 3H), 2.82 (ddd, J=14.3, 10.5, 4.8 Hz, 1H), 2.48 (ddd, J=13.5, 10.2, 6.7 Hz, 1H), 1.78 (dddd, J=13.6, 10.1, 6.6, 3.2 Hz, 1H), 1.74-1.67 (m, 3H), 1.61 (dd, J=26.0, 13.0 Hz, 2H), 1.46-1.36 (m, 1H), 1.24-1.15 (m, 3H), 1.13-1.03 (m, 2H), 1.01 (d, J=7.4 Hz, 3H), 0.74 (dqd, J=10.7, 7.4, 3.3 Hz, 1H), 0.68 (tt, J=12.7, 3.0 Hz, 1H), −0.11 (s, 3H), −0.12 (s, 3H), ¹³C NMR (151 MHz, CDCl₃) δ 143.3, 128.6, 128.4, 125.7, 35.2, 34.2, 28.37, 28.36, 27.9, 27.8, 27.2, 24.3, 17.2, 14.2, −6.9, ²⁹Si NMR (119 MHz, CDCl₃) δ 5.66, FTIR (cm⁻¹): 3026, 2919, 2847, 1604, 1496, 1446, 1246, 1099, 996, 888, 833, 799, 767, 698. HRMS (CI) m/z, calculated for [C₁₈H₂₉Si]⁺: 273.2039; found: 273.2031.

### Example 43—Synthesis of Compound (44)

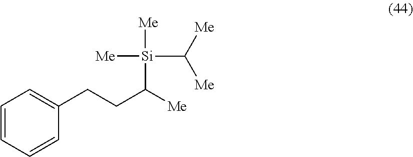 [SMILES: CC(C)[Si](C)(C)C(C)CCc1ccccc1]

According to procedure C, (DrewPhos)₂PdI₂ (16 mg, 10 μmol), Bu₂O (950 μL), isopropyldimethylsilyl chloride (310 μL, 2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) to afford compound (44) as a clear oil (210 mg, 90%): ¹H NMR (600 MHz, CDCl₃) δ 7.28 (t, J=7.6 Hz, 2H), 7.20-7.15 (m, 3H), 2.83 (ddd, J=14.8, 10.6, 4.8 Hz, 1H), 2.49 (ddd, J=13.5, 10.3, 6.6 Hz, 1H), 1.78 (dddd, J=13.7, 10.1, 6.6, 3.2 Hz, 1H), 1.41 (ddt, J=14.0, 10.5, 5.3 Hz, 1H), 1.02 (d, J=7.4 Hz, 3H), 0.95-0.90 (m, 6H), 0.88-0.81 (m, 1H), 0.76 (dqd, J=10.7, 7.4, 3.3 Hz, 1H), −0.10 (s, 3H), −0.11 (s, 3H), ¹³C NMR (151 MHz, CDCl₃) δ 143.2, 128.6, 128.4, 125.7, 35.2, 34.3, 18.0, 17.9, 17.5, 14.2, 12.1, −7.20, −7.23, FTIR (cm⁻¹): 3027, 2953, 2864, 1604, 1496, 1454, 1249, 997, 883, 832, 808, 765, 697. HRMS (CI) m/z, calculated for [C₁₄H₂₃Si]⁺: 219.1569; found: 219.1559.

### Example 44—Synthesis of Compound (45)

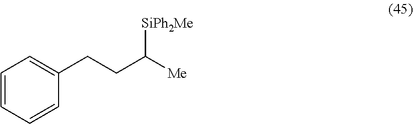

According to procedure C, (DrewPhos)₂PdI₂ (16 mg, 10 μmol), Bu₂O (850 μL), diphenylmethylsilyl chloride (410 μL, 2 mmol), and [1.34 M] (4-phenylbutan-2-yl)magnesium bromide (750 μL, 1.0 mmol) were combined under N₂ and stirred at RT for 24 h. After workup, crude product was purified via silica gel flash chromatography (hexanes) to afford compound (45) as a clear oil (315 mg, 95%): ¹H NMR (600 MHz, CD₂Cl₂) δ 7.50-7.47 (m, 4H), 7.39-7.31 (m, 6H), 7.24 (t, J=7.5 Hz, 2H), 7.16 (t, J=7.4 Hz, 1H), 7.10 (d, J=7.1 Hz, 2H), 2.80 (ddd, J=14.1, 9.9, 4.8 Hz, 1H), 2.50 (ddd, J=13.5, 9.5, 7.2 Hz, 1H), 1.91-1.82 (m, 1H), 1.51-1.43 (m, 1H), 1.41-1.33 (m, 1H), 1.09 (d, J=7.3 Hz, 3H), 0.53 (s, 3H), ¹³C NMR (151 MHz, CD₂Cl₂) δ 143.4, 137.4, 137.2, 135.40, 135.37, 129.7, 129.6, 129.1, 128.8, 128.37, 128.35, 126.2, 35.4, 34.5, 17.8, 14.5, −6.2, ²⁹Si NMR (119 MHz, CDCl₃) δ −4.7, FTIR (cm⁻¹): 3068, 2953, 2856, 1603, 1495, 1427, 1251, 1110, 788, 737, 698, 476. HRMS (CI) m/z, calculated for [C₂₂H₂₃Si]⁺: 315.1569; found: 315.1579.

### Example 45—Synthesis of Compound (46)

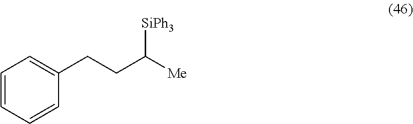

According to procedure D, (DrewPhos)₂PdI₂ (16 mg, 10 μmol), Bu₂O (1.25 mL), triphenylsilyl chloride (590 mg, 2 mmol), and [1.34 M] (4-phenylbutan-2-yl)magnesium bromide (750 μL, 1.0 mmol) were combined under N₂ and stirred at 50° C. for 24 h. After workup, crude product was purified via silica gel flash chromatography (hexanes:DCM 100:0 to hexanes:DCM 90:10) to afford compound (46) as a viscous clear oil (267 mg, 68%): ¹H NMR (600 MHz, CD₂Cl₂) δ 7.50 (dd, J=8.0, 1.4 Hz, 6H), 7.42-7.37 (m, 3H), 7.37-7.31 (m, 6H), 7.26 (t, J=7.5 Hz, 2H), 7.17 (t, J=7.4 Hz, 1H), 7.12 (d, J=7.0 Hz, 2H), 2.86 (ddd, J=13.8, 9.3, 4.7 Hz, 1H), 2.57 (dt, J=13.5, 8.3 Hz, 1H), 2.09-2.02 (m, 1H), 1.75-1.68 (m, 1H), 1.52-1.44 (m, 1H), 1.21 (d, J=7.3 Hz, 3H), ¹³C NMR (151 MHz, CDCl₃) δ 143.2, 136.5, 135.2, 129.9, 129.2, 128.8, 128.4, 126.3, 35.3, 34.7, 16.7, 14.8, ²⁹Si NMR (119 MHz, CD₂Cl₂) 6-8.7, FTIR (cm-1): 3067, 3024, 2935, 2856, 1602, 1495, 1428, 1189, 1108, 998, 741, 698, 575, 510. HRMS (CI) m/z, calculated for [C₂₂H₂₃Si]⁺: 315.1569; found: 315.1578.

### Example 46—Synthesis of Compound (47)

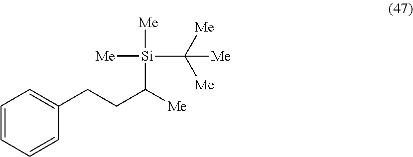 [SMILES: CC(CCc1ccccc1)[Si](C)(C)C(C)(C)C]

According to procedure D, (DrewPhos)₂PdI₂ (16 mg, 10 μmol), Bu₂O (1.25 mL), tert-butyldimethylsilyl chloride (300 mg, 2 mmol), and [1.34 M] (4-phenylbutan-2-yl)magnesium bromide (750 μL, 1.0 mmol) were combined under N₂ and stirred at 100° C. for 24 h. After workup, crude product was purified via silica gel flash chromatography (hexanes) to afford compound (47) as a clear oil (74 mg, 30%): ¹H NMR (600 MHz, CD₂Cl₂) δ 7.26 (t, J=7.6 Hz, 2H), 7.20-7.14 (m, 3H), 2.83 (ddd, J=13.7, 10.5, 4.8 Hz, 1H), 2.48 (ddd, J=13.4, 10.2, 6.6 Hz, 1H), 1.85 (dddd, J=13.5, 10.2, 6.6, 2.9 Hz, 1H), 1.48-1.39 (m, 1H), 1.07 (d, J=7.4 Hz, 3H), 0.89 (s, 9H), 0.85 (ddq, J=15.0, 7.5, 4.5, 3.6 Hz, 1H), −0.070 (s, 3H), −0.075 (s, 3H), ¹³C NMR (151 MHz, CDCl₃) δ 143.2, 128.6, 128.4, 125.7, 35.2, 35.0, 27.6, 17.6, 17.4, 15.2, −7.0, ²⁹Si NMR (119 MHz, CDCl₃) δ 9.7, FTIR (cm⁻¹): 3027, 2928, 2856, 1604, 1470, 1250, 828, 765, 697. HRMS (CI) m/z, calculated for [C₁₅H₂₅Si]⁺: 233.1726; found: 233.1722.

### All-Chloride Experiments

### Synthesis of (DrewPhos)₂PdI₂

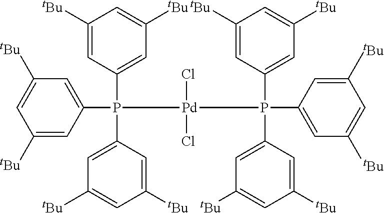

A 100 mL round bottom flask equipped with a magnetic stirbar was charged with bis(acetonitrile)dichloropalladium(II) (259 mg, 1 mmol, 1.0 equiv.) and DrewPhos (1.2 g, 2 mmol, 2.0 equiv.). The flask was sealed with a rubber septum and purged 10 min with N₂. CH₂Cl₂ (20 mL) was added via syringe and the solution was stirred for 6 hours at RT. The solvent was then removed in vacuo. EtOAc (15 mL) was added and the flask sat overnight at RT. The solid was collected via vacuum filtration and rinsing with EtOH resulted in a stable, yellow solid (905 mg, 66% yield): ¹H NMR (600 MHz, CDCl₃) δ 7.52-7.48 (m, 12H), 7.38 (s, 6H), 1.19 (s, 108H); ¹³C NMR (151 MHz, CDCl₃) δ 149.69 (t, J=5.0 Hz), 130.41 (t, J=23.9 Hz), 129.87 (t, J=6.4 Hz), 123.83, 35.01, 31.54, ³¹P NMR (243 MHz, CDCl₃) δ 26.82; FTIR (cm⁻¹): 2963, 2903, 2868, 1590, 1477, 1421, 1363, 1266, 1249, 1138, 731, 705, 586; mp=>250° C. HRMS (LIFDI) m/z, calculated for [C₈₄H₁₂₆P₂PdCl₂]⁺: 1372.7747; found: 1372.7599.

### Synthesis of Isopropylmagnesium Chloride

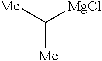

An oven-dried 25 mL round-bottom flask equipped with a magnetic stirbar and rubber septum was attached to a double manifold and cooled under vacuum. The flask was backfilled with N₂, the septum removed, magnesium turnings (1.1 g, 45 mmol, 1.5 equiv.) were added. The septum was replaced; the flask was attached to a double manifold and purged with N₂ for 10 min. The flask was held under positive N₂ then Et₂O (10 mL, [3 M]) was added. An initial amount of alkyl halide (˜200-400 μL) was added and the reaction to start the reaction as evidenced by a minor exotherm. If reaction does not initiate, gentle warming (for example with a heating mantle) may be necessary. Once initiated, the flask was placed in a RT water bath and the remaining alkyl halide (2.74 mL, 2.36 g, 30 mmol, 1 equiv., total addition amount) was added dropwise over −30 min. After full addition of the alkyl halide, the mixture was allowed to stir at RT for an additional 4 h. The excess magnesium was allowed to settle and the mixture was filtered via cannula to a Schlenk tube. Titration resulted in a [2.65 M] solution of isopropylmagnesium chloride. In this preparation, 12 was not used to activate the magnesium turnings.

All-Chloride Process According to the Present Invention

In a nitrogen filled glovebox, a 1-dram vial equipped with a magnetic stirbar was charged with (DrewPhos)₂PdCl₂ (3.4 mg, 2.5 μmol, 0.01 equiv.), Et₂O (350 μL) or Bu₂O (350 μL), and dimethylphenylsilyl chloride (50 μL, 51 mg, 300 μmol, 1.2 equiv.). Vial was then sealed with a septum cap and removed from the glovebox. Isopropylmagnesium chloride [2.65 M] (94 μL, 250 μmol, 1 equiv.) was then added via syringe and the vial was then stirred at the indicated temperature for 24 h. The reaction was quenched with Et₂O (1 mL) then H₂O (0.5 mL) via syringe. n-Nonane (32 mg, 45 μL, 0.25 mmol, 1 equiv.) and 1,3,5-trimethoxybenzene (TMB) (14 mg, 0.25 mmol, 0.33 equiv.) were added as GC internal standards. Brine (1 mL) and Et₂O (1 mL) were then added and the vials shaken. An aliquot was then filtered through a MgSO₄ and silica plug. The solution was directly analyzed by GC.

TABLE 1
All-Chloride Conditions

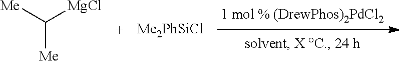

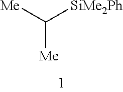

| Entry | Solvent | Temp | Additive | Yield (%)^{a} |
|---|---|---|---|---|
| 1 | Et₂O | rt | — | 6 |
| 2 | Bu₂O | 50° C. | — | 70 |
| 3 | Et₂O | rt | 0.25 equiv TMEDA | 52 |

^{a}Yields determined by GC. All reactions gave >99:1 B:L selectivity by GC.

All reactions in the following paragraphs were performed at 0.25 mmol in a nitrogen-filled glovebox with a [0.5 M] overall concentration based on the sum of all liquid reagents.

Examination of Stoichiometry

In a nitrogen filled glovebox, a 1-dram vial equipped with a magnetic stirbar was charged with (DrewPhos)₂PdI₂ (4 mg, 2.5 μmol, 0.01 equiv.), Et₂O (330 μL), and dimethylphenylsilyl chloride (52 μL, 53 mg, 313 μmol, 1.25 equiv., or 46 μL, 47 mg, 275 μmol, 1.1 equiv., or 42 μL, 43 mg, 250 μmol, 1 equiv.). Vial was then sealed with a septum cap and removed from the glovebox. Isopropylmagnesium bromide [2.13 M](117 μL, 250 μmol, 1 equiv., or 129 μL, 275 μL, 1.1 equiv., or 147 μL, 313 μmol, 1.25 equiv.) was then added via syringe and the vial was then stirred at RT for the indicated time. The reaction was quenched with Et₂O (1 mL) then H₂O (0.5 mL) via syringe. n-Nonane (32 mg, 45 μL, 0.25 mmol, 1 equiv.) and 1,3,5-trimethoxybenzene (TMB) (14 mg, 0.25 mmol, 0.33 equiv.) were added as GC internal standards. Brine (1 mL) and Et₂O (1 mL) were then added and the vials shaken. An aliquot was then filtered through a MgSO₄ and Silica plug. The solution was directly analyzed by GC.

TABLE 2
Effect of Stoichiometry

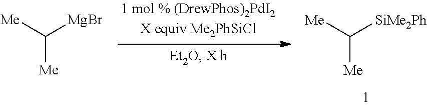

| Entry | Mg:Si | 4 h (%)^{a} | 8 h (%)^{a} | 24 h (%)^{a} |
|---|---|---|---|---|
| 1 | 1:1.25 | 99 | 99 | 99 |
| 2 | 1:1.1 | 78 | 96 | 99 |
| 3 | 1:1 | 73 | 90 | 97 |
| 4 | 1.1:1 | 74 | 88 | 93 |
| 5 | 1.25:1 | 71 | 86 | 93 |

^{a}Yields determined by GC. All reactions gave >99:1 B:L selectivity by GC.

Examination of Ethereal Solvents

In a nitrogen filled glovebox, a 1-dram vial equipped with a magnetic stirbar was charged with (DrewPhos)₂PdI₂ (4 mg, 2.5 μmol, 0.01 equiv.), MTBE or CPME (280 μL), and triethylsilyl chloride (84 μL, 75 mg, 500 μmol, 2 equiv.) or isopropyldimethylsilyl chloride (78 μL, 68 mg, 500 μmol, 2 equiv.). Vial was then sealed with a septum cap and removed from the glovebox. (4-phenylbutan-2-yl)magnesium bromide [1.78 M] (140 μL, 250 μmol, 1 equiv.) was then added via syringe and the vial was then stirred at 50° C. for the indicated time. The reaction was quenched with Et₂O (1 mL) then H₂O (0.5 mL) via syringe. n-Nonane (32 mg, 45 μL, 0.25 mmol, 1 equiv.) and 1,3,5-trimethoxybenzene (TMB) (14 mg, 0.25 mmol, 0.33 equiv.) were added as GC and NMR internal standards. Brine (1 mL) and Et₂O (1 mL) were then added and the vials shaken. An aliquot was then filtered through a MgSO₄ and Silica plug. The solution was directly analyzed by GC then concentrated in vacuo and analyzed by NMR.

TABLE 3
Examination of Ethereal Solvents

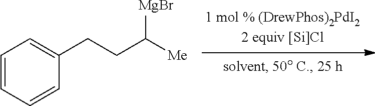

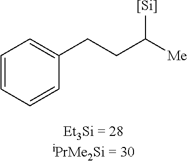

| Entry | [Si] | MTBE | CPME |
|---|---|---|---|
| 1 | Et₃Si | 99 | 99 |
| 2 | ⁱPrMe₂Si | 97 | 90 |

^{a}Yields determined by NMR. All reactions gave >99:1 B:L selectivity by GC.

Examination of Silyl Electrophiles

The use of other silyl electrophiles other than silyl iodides was also examined. Previous studies have shown that the addition of iodide additives can be beneficial with use of silyl chlorides, bromides, and triflates, so the reaction was also examined with NaI additive. The results show minimal reactivity with Me₃SiBr in the absence of NaI, and modest reactivity with. For silyl chlorides and triflates, negligible reactivity was observed with or without NaI.

In a nitrogen filled glovebox, a 1-dram vial equipped with a magnetic stirbar was charged with (DrewPhos)₂PdI₂ (0.01 equiv.), dioxane, triethylamine (1 equiv.), and trimethylsilyl halide (2 equiv.). Vial was then sealed with a septum cap and removed from GB. (4-phenylbutan-2-yl)zinc bromide (1 equiv.) was added via syringe and the flask was then stirred at RT for 4 h. The reaction was quenched with Et₂O (1 mL) then H₂O (0.5 mL) via syringe. Nonane (32 mg, 45 μL, 0.25 mmol, 1 equiv.) and 1,3,5-trimethoxybenzene (TMB) (14 mg, 0.25 mmol, 0.33 equiv.) were added as GC and NMR internal standards respectively. Brine (1 mL) and Et₂O (1 mL) were then added and the vials shaken. An aliquot was then filtered through a MgSO₄ and Silica plug. The solution was directly analyzed by GC. The solvent was removed in vacuo then analyzed by NMR.

TABLE 4
Examination of Silyl Electrophiles

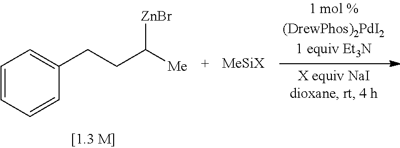

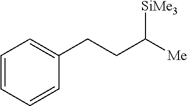 [SMILES: CC(CCc1ccccc1)[Si](C)(C)C]

| Entry | Me₃SiX | 0 equiv NaI^{a} | 3 equiv NaI^{a} |
|---|---|---|---|
| 1 | Me₃SiI | 98% | 99% |
| 2 | Me₃SiBr | 26% | 61% |
| 3 | Me₃SiCl | 1% | 11% |
| 4 | Me₃SiOTf | 2% | 5% |

^{a}Yields obtained by ¹H NMR with TMB as an internal standard.

Examination of Dibutyl Zinc Reactivity

The use of dialkylzinc reagents in the coupling reaction was also examined. As can be seen in Table 5, with Bu₂Zn only trace background reaction is observed, which is comparable to the background reaction with BuZnBr. Under palladium-catalyzed conditions, quantitative alkylation resulted. Et₃N does not effect this reaction. It is notable that only 0.5 equiv of Bu₂Zn is required in this reaction, both alkyl groups transfer to the product.

In a nitrogen filled glovebox, a 1-dram vial equipped with a magnetic stirbar was charged with (DrewPhos)₂PdI₂ (0.01 equiv.), dioxane, triethylamine (1 equiv.), and dimethylphenylsilyl iodide (2 equiv.), and dibutylzinc (0.5 equiv.). Vial was then sealed with a septum cap, removed from GB, and stirred at RT for 4 h. The reaction was quenched with Et₂O (1 mL) then H₂O (0.5 mL) via syringe. Nonane (32 mg, 45 μL, 0.25 mmol, 1 equiv.) and 1,3,5-trimethoxybenzene (TMB) (14 mg, 0.25 mmol, 0.33 equiv.) were added as GC and NMR internal standards respectively. Brine (1 mL) and Et₂O (1 mL) were then added and the vials shaken. An aliquot was then filtered through a MgSO₄ and Silica plug. The solution was directly analyzed by GC. The solvent was removed in vacuo then analyzed by NMR.

TABLE 5
Reactivity of Dibutylzinc

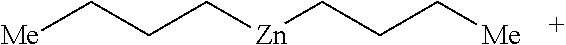

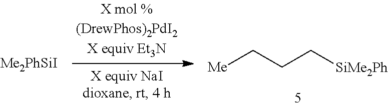

| Entry | % Pd | 1 equiv Et₃N^{a} | 0 equiv Et₃N^{a} |
|---|---|---|---|
| 1 | 1 | 99% | 99% |
| 2 | 0 | 7% | 7% |

^{a}Yields obtained by ¹H NMR with TMB as an internal standard.

Isolation of the palladium catalyzed reaction in the presence of triethylamine via flash chromatography (hexanes) afforded 5 as a clear oil (42 mg, 88%): ¹H NMR (400 MHz, CDCl₃) δ 7.54-7.50 (m, 2H), 7.37-7.34 (m, 3H), 1.36-1.26 (m, 4H), 0.88 (t, J=6.9 Hz, 3H), 0.79-0.73 (m, 2H), 0.26 (s, 6H); ¹³C NMR (101 MHz, CDCl₃) δ 139.9, 133.7, 128.9, 127.8, 26.7, 26.3, 15.6, 13.9, −2.9.

Examination of Alkene Additives

Alkenes appear to interfere with the reaction, as is reflected in the study shown in Table 6. This appears to be a function of alkene substitution, as the effect is most notable with lower substituted alkenes.

In a nitrogen filled glovebox, a 1-dram vial equipped with a magnetic stirbar was charged with (DrewPhos)₂PdI₂ (0.01 equiv), dioxane, triethylamine (1 equiv), alkene (1 equiv) and trimethylsilyl halide (2 equiv). Vial was then sealed with a septum cap and removed from GB. Isopropylzinc bromide (1 equiv) was added via syringe and the flask was then stirred at RT for 4 h. The reaction was quenched with Et₂O (1 mL) then H₂O (0.5 mL) via syringe. Nonane (32 mg, 45 μL, 0.25 mmol, 1 equiv) and 1,3,5-trimethoxybenzene (TMB) (14 mg, 0.25 mmol, 0.33 equiv) were added as GC and NMR internal standards respectively. Brine (1 mL) and Et₂O (1 mL) were then added and the vials shaken. An aliquot was then filtered through a MgSO₄ and Silica plug. The solution was directly analyzed by GC. The solvent was removed in vacuo then analyzed by NMR.

TABLE 6
Impact of Alkene Additives

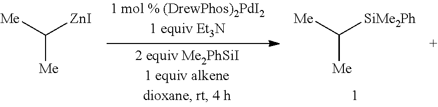

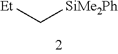

| Entry | Alkene | 1 + 2%^{a} | 1:2^{b} |
|---|---|---|---|
| 1 | None | 98 | >99:1 |
| 2 | 4-octene | 55 | 98:2 |
| 3 | 1-methyl- | 99 | >99:1 |
| | cyclohexene | | |
| 4 | (+)-limonene | 75 | >99:1 |

^{a}Yields obtained by ¹H NMR with TMB as an internal standard.
^{b}Ratio determined by GC.

1. A process for preparing a compound of formula (I): 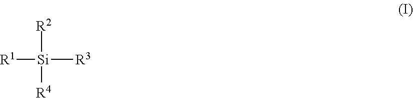
comprising the step of reacting
a compound of formula (II):
R¹-MX (II)
wherein
M is Zn or Mg;
R¹ is an alkyl, alkenyl, alkynyl, cycloalkyl, cycloalkenyl, cycloalkynyl, heterocycloalkyl, heterocycloalkenyl, heterocycloalkynyl, aryl, or heteroaryl group, each of which is optionally substituted with one or more substituents, wherein at least one of the one or more substituents is optionally a moiety of formula -M′X′, wherein M′ is Zn or Mg and X′ is Cl, Br, or I; and
X is Cl, Br, or I, or, when R¹ is an alkyl group, X is optionally an alkyl group identical to that of R¹;
with a compound of formula (III): 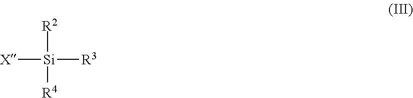
wherein
X″ is Cl, Br, I, —OS(O)₂alkyl, —OS(O)₂perfluoroalkyl, or OS(O)₂aryl; and
R², R³, and R⁴
are, independently, selected from the group consisting of alkyl, alkenyl, alkynyl, cycloalkyl, cycloalkenyl, cycloalkynyl, heterocycloalkyl, heterocycloalkenyl, heterocycloalkynyl, aryl, heteroaryl, wherein each alkyl, alkenyl, alkynyl, cycloalkyl, cycloalkenyl, cycloalkynyl, heterocycloalkyl, heterocycloalkenyl, heterocycloalkynyl, aryl, heteroaryl group is optionally substituted with one or more substituents, Cl, Br, I, —OS(O)₂alkyl groups, —OS(O)₂perfluoroalkyl groups, and —OS(O)₂aryl groups, wherein at least one of the one or more substituents is optionally a moiety of formula —SiR⁵R⁶X′″, wherein R⁵ and R⁶ are each, independently, selected from the group consisting of alkyl, alkenyl, alkynyl, cycloalkyl, cycloalkenyl, cycloalkynyl, heterocycloalkyl, heterocycloalkenyl, heterocycloalkynyl, aryl, heteroaryl, each of which is optionally substituted with one or more substituents, and X′″ is Cl, Br, I, —OS(O)₂alkyl, —OS(O)₂perfluoroalkyl, or —OS(O)₂aryl; and
wherein R², R³, and/or R⁴, when taken together, optionally define an optionally substituted ring system;
in the presence of a catalyst comprising a Group 8, 9, or 10 transition metal, a ligand, a solvent, and, optionally, an additive;
wherein R², R³, and/or R⁴ are optionally covalently linked to R¹; and
R¹, R², R³, and R⁴ of the compound of formula (I) are as defined above.

2. The process of claim 1, wherein R¹ is sterically hindered.

3. The process of claim 1, wherein R¹ is selected from the group consisting of primary, secondary, and tertiary alkyl groups, primary, secondary and tertiary alkenyl groups, and primary, secondary and tertiary alkynyl groups, each of which is optionally substituted.

4. The process of claim 1, wherein one or more of R¹, R², R³, and R⁴ is substituted with a least one silyl group.

5. The process of claim 1, wherein R² is selected from the group consisting of Cl, Br, I, —OS(O)₂alkyl groups, —OS(O)₂perfluoroalkyl groups, and —OS(O)₂aryl groups.

6. The process of claim 5, wherein X″ and R² are both Cl.

7. The process of claim 1, wherein R³ is selected from the group consisting of Cl, Br, I, —OS(O)₂alkyl groups, —OS(O)₂perfluoroalkyl groups, and —OS(O)₂aryl groups.

8. The process of claim 1, wherein X″, R², and R³ are all Cl.

9. The process of claim 1, wherein R⁴ is selected from the group consisting of Cl, Br, I, —OS(O)₂alkyl groups, —OS(O)₂perfluoroalkyl groups, and —OS(O)₂aryl groups.

10. The process of claim 1, wherein the Group 8, 9, or 10 transition metal is selected from the group consisting of Pd, Ni, Co, Rh, and Ir.

11. The process of claim 1, wherein the catalyst comprises Pd and is selected from the group consisting of Pd(OAc)₂, PdBr₂, PdI₂, Pd(dba)₂, Pd(dba)₃, [allylPdCl]₂, Pd₂dba₃.CHCl₃, [(3,5-C₆H₃(t-Bu)₂)₃P]₂PdI₂, [(3,5-C₆H₃(t-Bu)₂)₃P]₂PdCl₂, (COD)Pd(CH₂TMS)₂, (COD)PdCl₂, (PPh₃)₂PdCl₂, (PPh₃)₄Pd, (MeCN)₂PdCl₂, and (IPr)₂PdCl₂.

12. The process of claim 1, wherein the catalyst comprises Ni and is selected from the group consisting of Ni halides, Ni halide solvent complexes, and Ni(COD)₂.

13. The process of claim 1, wherein the ligand is selected from the group consisting of phosphine ligands, arsine ligands, nitrogen-containing ligands, and N-heterocyclic carbene ligands.

14. The process of claim 1, wherein the ligand is selected from the group consisting of PPh₃, (3,5-t-BuC₆H₃)₂P(tBu), Ph₂P(tBu), PhP(t-Bu)₂, (3,5-C₆H₃(t-Bu)₂)₃P, (4-MeO—C₆H₄)₃P, (t-Bu)₃P, (t-Bu)₂PCy, (t-Bu)PCy₂, Cpy₃P, Cy₂PMe, Cy₂PEt, Cy₃P, (o-tol)₃P, (furyl)₃P, (4-F—C₆H₄)₃P, (4-CF₃—C₆H₄)₃P, BIPHEP, NapthPhos, XantPhos, dppf, dppe, dppb, dpppe, dcpe, dcpp, dcpb, SPhos, XPhos, DavePhos, JohnPhos, BrettPhos, QPhos, AmgenPhos, RockPhos, RuPhos, VPhos, tBuXPhos, tBuBrettPhos, TrixiePhos, AZPhos, CPhos, (3,5-t-BuC₆H₃)₂P(iPr), (3,5-t-BuC₆H₃)₂P(Et), (3,5-t-BuC₆H₃)₂P(Me), (3,5-i-PrC₆H₃)₂P(tBu), (3,5-i-PrC₆H₃)₂P(iPr), (3,5-i-PrC₆H₃)₂P(Et), (3,5-i-PrC₆H₃)₂P(Me), (3,5-t-Bu-4-MeO—C₆H₂)₂P(tBu), (3,5-t-Bu-4-MeO—C₆H₂)₃P, BINAP, SIPr, IPr, IMes, ISMes, and derivatives thereof.

15. The process of claim 1, wherein the solvent is selected from the group consisting of dioxane, toluene, 1,2-dichloroethane, acetonitrile, dibutyl ether, diethyl ether, hexane, tetrahydrofuran, and mixtures thereof.

16. The process of claim 1, wherein at least one additive is present during the reaction and is selected from the group consisting of trialkylamines and iodide salts.

17. The process of claim 1, wherein at least one additive is present during the reaction and the at least one additive includes at least one of triethylamine or TMEDA.

18. The process of claim 1, wherein at least one additive is present during the reaction and the at least one additive includes at least one of LiI, NaI, KI, or ammonium iodide.

19. The process of claim 1, wherein M and X of the compound of formula (II) are Zn and Br or I, respectively, X″ of the compound of formula (III) is I, the catalyst is [(3,5-C₆H₃(t-Bu)₂)₃P]₂PdI₂, the additive is triethylamine, and the solvent is dioxane.

20. The process of claim 1, wherein M and X of the compound of formula (II) are Mg and Br or I, respectively, X″ of the compound of formula (III) is Cl, the catalyst is [(3,5-C₆H₃(t-Bu)₂)₃P]₂PdI₂, and the solvent is Et₂O.

21. A compound of formula (I): 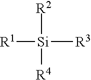
wherein
R¹, R², R³, and R⁴
are each, independently, an alkyl, alkenyl, alkynyl, cycloalkyl, cycloalkenyl, cycloalkynyl, heterocycloalkyl, heterocycloalkenyl, heterocycloalkynyl, aryl, or heteroaryl group, each of which is optionally substituted with one or more substituents;
wherein
R², R³, and/or R⁴, when taken together, optionally define an optionally substituted ring system; and R², R³, and/or R⁴ are optionally covalently linked to R¹.

22. The compound of claim 21, wherein R¹ is sterically hindered.

23. The compound of claim 21, wherein R¹ is selected from the group consisting of secondary and tertiary alkyl groups, secondary and tertiary alkenyl groups, and secondary and tertiary alkynyl groups, each of which is optionally substituted.

24. The compound of claim 21, wherein one or more of R¹, R², R³, and R⁴ is substituted with a least one silyl group.

25. The compound of claim 21, wherein the compound is selected from the group consisting of compounds of formulae (2), (3), (7)-(9), (13), (16)-(23), (25)-(27), and (30)-(47):

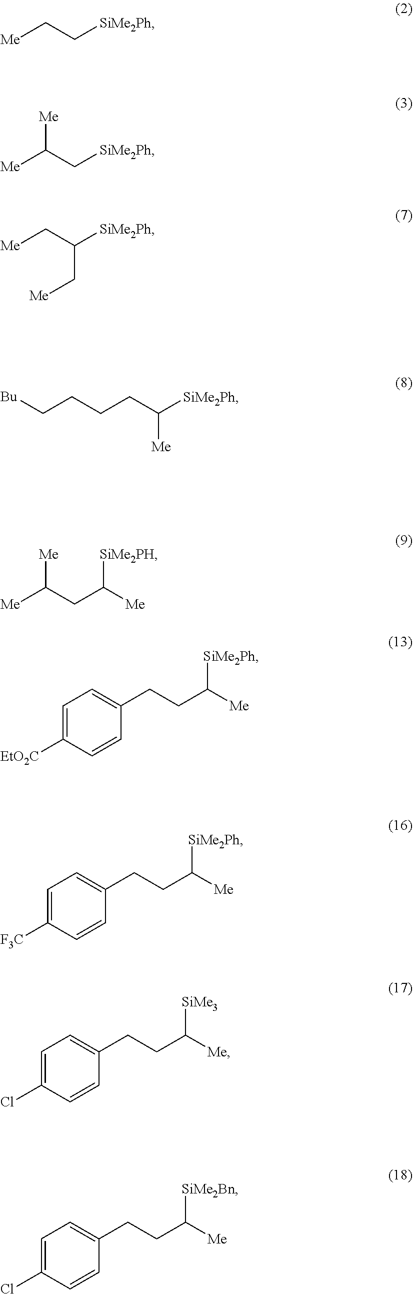

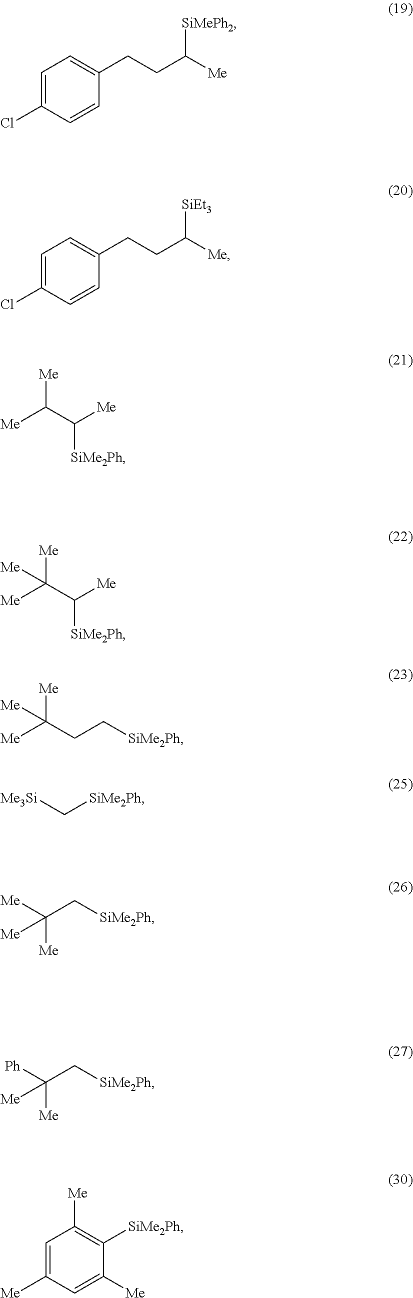

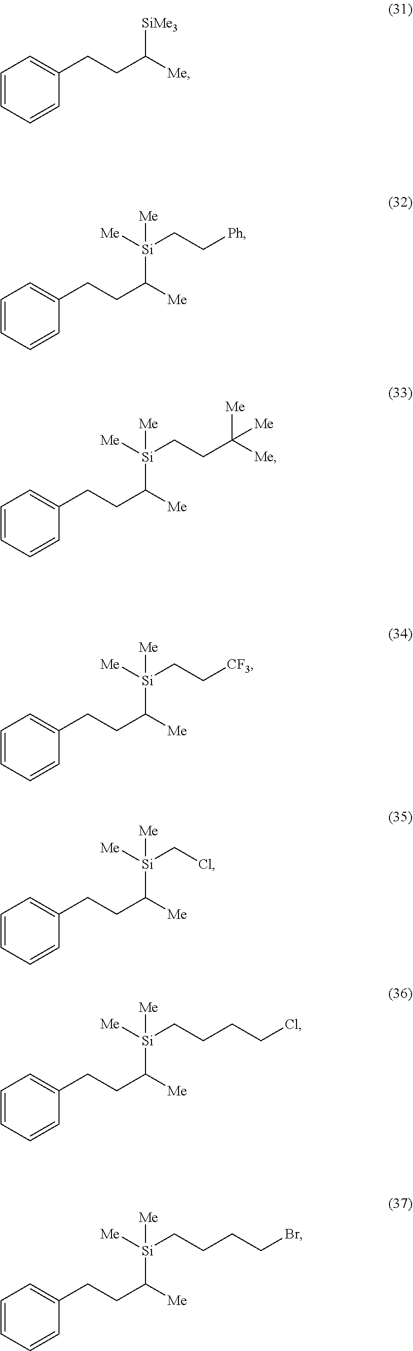

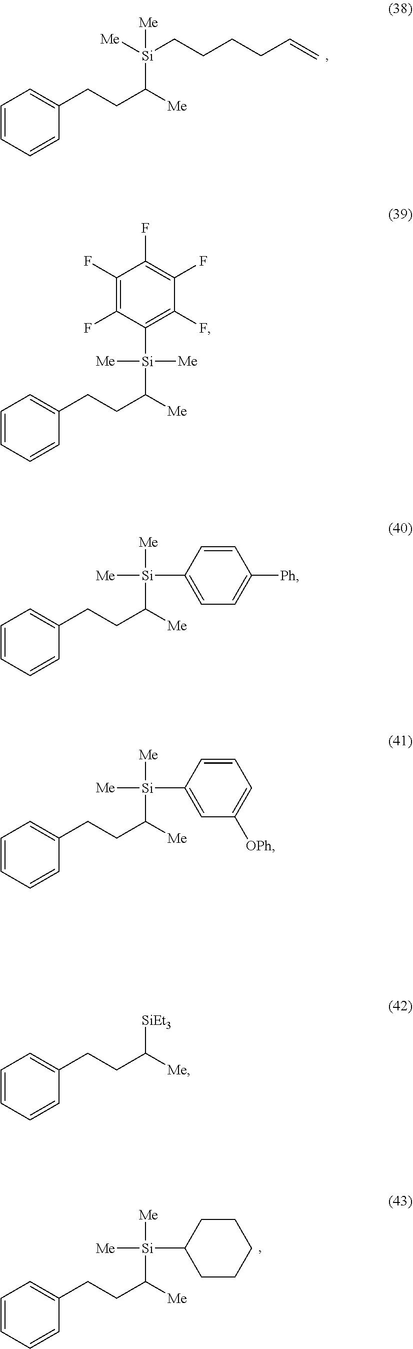

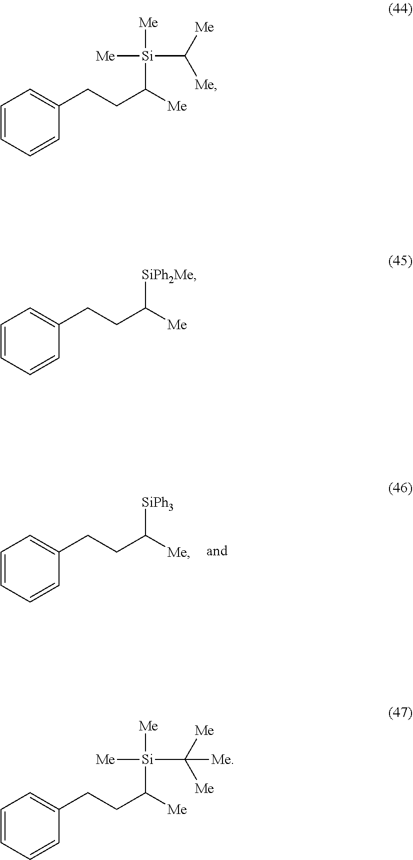

26. A composition comprising at least one compound of claim 21.

27. The composition of claim 26, wherein the composition is selected from the group consisting of aerospace materials, pharmaceuticals, agrochemicals, rubber materials, lubricants, hydraulic fluids, damping fluids, diffusion pump fluids, cryogenic fluids, waterproofing agents, hydrophobing agents, heat transfer media, anti-stick coatings, and fuel additives.
